(19) United States
(12) Patent Application Publication
(10) Pub. No.: US 2023/0312000 A1
(43) Pub. Date: Oct. 5, 2023

(54) Transport System

(71) Applicant: Boxabl Inc., Las Vegas, NV (US)

(72) Inventors: Paolo Tiramani, Las Vegas, NV (US); Kyle Denman, North Las Vegas, NV (US); Cody Loveland, Henderson, NV (US); Ethan Wolf, Henderson, NV (US); Hunter Davis, North Las Vegas, NV (US)

(21) Appl. No.: 18/118,770

(22) Filed: Mar. 8, 2023

Related U.S. Application Data
(60) Provisional application No. 63/335,880, filed on Apr. 28, 2022.
(60) Provisional application No. 63/324,940, filed on Mar. 29, 2022.

(51) Int. Cl. B62D 21/20

(52) U.S. Cl. CPC B62D 21/20; B62D 63/08

(57) ABSTRACT

A transport system, with first, second, third and fourth I-beams, joined to form a planar rectangular chassis frame having an upper edge, a lower edge, and first, second, third and fourth corners. A first cross-bar having a first end is joined proximate to the upper edge of the chassis frame and the first corner, and a second end is joined proximate to the lower edge of the first chassis frame and the second corner. A second cross-bar having a first end is joined proximate to the upper edge of the chassis frame and the third corner, and a second end joined proximate to the lower edge of the chassis frame and the fourth corner.

### CROSS-REFERENCE TO RELATED APPLICATIONS

This application claims the benefit of U.S. Provisional Patent Application No. 63/324,940, which was filed on Mar. 29, 2022, and U.S. Provisional Patent Application No. 63/335,880, which was filed on Apr. 28, 2022. The entire content of the foregoing provisional applications is incorporated herein by reference.

### BACKGROUND OF THE INVENTION

### Field of the Invention

These inventions relate to means for transporting items, such as rectilinear boxes, containers and the like, over relatively flat surfaces, such as roads and highways. In one embodiment, these inventions relate to means for transporting to a building site an assembly of interrelated components utilized for constructing structures, such as dwellings and other buildings, for residential occupancy, commercial occupancy and/or material storage.

### Description of Related Art

In the field of residential housing, the traditional technique for building homes is referred to as “stick-built” construction, where a builder constructs housing at the intended location using in substantial part raw materials such as wooden boards, plywood panels, poured concrete, cinder blocks and so forth. The materials are assembled piece by piece over a previously prepared portion of ground, for example, a poured concrete slab or a poured concrete or cinder block foundation.

There have been a variety of efforts to depart from the conventional construction techniques used to create dwellings, as well as commercial spaces and like. Among the more attractive alternatives to stick-built construction are foldable, transportable structures, such as described in U.S. Pat. Nos. 8,474,194; 10,926,689; and 11,118,344. These alternatives are directed to components, such as wall, floor and ceiling components, which are manufactured, appropriately positioned and secured together as a folded, transportable structure, and then delivered to the intended location. The components can then be deployed to form a relatively finished structure suitable for human or material occupancy, such as housing, offices, retail space, and warehouse use.

The movement of a folded, transportable structure from factory to the intended location can be done using a conventional truck trailer or a low bed trailer (also referred to as a lowboy trailer). An alternative to the use of such conventional trailers is disclosed in U.S. Pat. No. 11,007,921, issued May 18, 2021, which features leading and trailing transport assemblies of the same design, which are respectively secured to the forward and rear transverse edges of a folded, transportable structure.

### SUMMARY OF THE INVENTION

The present inventions, which are directed to various aspects of a transport system, provide an easy and efficient means for the movement of items such as rectilinear boxes, containers and the like, over relatively flat surfaces, such as roads and highways. The transport system described herein allows the movement of a folded, transportable structure that dispenses with the use of a tractor trailer, as delivery can be accomplished using a pick-up truck equipped with a trailer hitch. In addition, the described transport system provides options for equipping the folded, transportable structure at its destination with various components of the transport system, which facilitates deployment possibilities and finished structure robustness, and also provides a number of movement and return options for the transport system and its assemblies.

In one aspect, the present inventions are directed to a transport system comprising first, second, third and fourth I-beams, which are joined to form a planar rectangular first chassis frame having an upper edge, a lower edge, a first corner at a junction of the first I-beam and the second I-beam, a second corner diagonally across from the first corner at a junction of the third I-beam and the fourth I-beam, a third corner at a junction of the first I-beam and the fourth I-beam and a fourth corner diagonally across from the third corner at a junction of second I-beam and the third I-beam. There is provided a first cross-bar having a first end joined proximate to the upper edge of the first chassis frame and the first corner, and a second end joined proximate to the lower edge of the first chassis frame and the second corner; and there is also provided a second cross-bar having a first end joined proximate to the upper edge of the first chassis frame and the third corner, and a second end joined proximate to the lower edge of the first chassis frame and the fourth corner.

In another aspect, the present inventions are directed to a transport system having first, second, third and fourth I-beams, which are joined to form a planar rectangular first chassis frame having an upper edge and a lower edge, with the first and third I-beams each joined to the second and fourth I-beams. There is provided a first cross-bar having a first end joined proximate to the upper edge of the first chassis frame and a junction between the first and fourth I-beams, with the first cross-bar extending diagonally away from the first and fourth I-beams and terminating at a second end joined to the second I-beam at the lower edge of the first chassis frame; and there is also provided a second cross-bar having a first end joined proximate to the upper edge of the first chassis frame and a junction between the first and second I-beams, with the second cross-bar extending diagonally away from the first and second I-beams and terminating at a second end joined to the fourth I-beam at the lower edge of the first chassis frame.

In a further aspect, the present inventions are directed to a stackable transport system comprising first, second, third and fourth beams that are joined to form a planar rectangular first chassis frame having an upper edge, a lower edge, a first corner at a junction of the first beam and the second beam, a second corner diagonally across from the first corner at a junction of the third beam and the fourth beam, a third corner at a junction of the first beam and the fourth beam and a fourth corner diagonally across from the third corner at a junction of the second beam and the third beam. There is provided a forward assembly comprising a first axle sub-assembly and a steering sub-assembly, with the first axle sub-assembly having a plurality of wheels for rolling contact with a prepared or unprepared surface and being connected with an articulated joint to the steering sub-assembly. The steering sub-assembly is fastened to the first beam. There is additionally provided a trailing assembly comprising a second axle sub-assembly having a second plurality of wheels for rolling contact with a prepared or unprepared surface, with the trailing assembly fastened to the third beam. A first extendible element is fastened to the first chassis frame proximate to the first corner, a second extendible element is fastened to the first chassis frame proximate to the second corner, a third extendible element is fastened to the first chassis frame proximate to the third corner, and a fourth extendible element is fastened to the first chassis frame proximate to the fourth corner. Each extendible element has a first end located proximate to or above the upper edge of the first chassis frame and a second end located proximate to or below the lower edge of the first chassis frame, with the first end of each extendible element having a first of a positioning element and a receiver element mounted thereon, and the second end of each extendible element having a second of the positioning element and the receiver element mounted thereon. The first of the positioning element and the receiver element of each of the first, second, third and fourth extendible elements is adapted to mate with the second of the positioning element and the receiver element respectively mounted on each of a fifth, sixth, seventh and eighth extendible elements fastened to a planar rectangular second chassis frame.

In yet an additional aspect, the present inventions are directed to a rolling component transport assembly comprising a forward assembly having a first axle sub-assembly and a steering sub-assembly, where the first axle sub-assembly comprises a first plurality of wheels for rolling contact with a prepared or unprepared surface, and a planar first axle frame having a first steering sleeve, with the first axle frame joined to the first plurality of wheels, and with the steering sub-assembly comprising a planar steering frame including a steering extender having a first end and a second end. A steering tube is joined to the second end of the steering extender and inserted into the first steering sleeve of the first axle sub-assembly to provide an articulated joint between the first axle sub-assembly and the steering sub-assembly. There is provided a first steering stay joined to the steering frame and extending orthogonally to a geometrical plane containing the steering frame, and a second steering stay joined to the steering frame and extending orthogonally to the geometrical plane containing the steering frame. The first and second steering stays are each adapted to be fastened to a first beam of a planar rectangular chassis frame. There is also provided a trailing assembly having a second axle sub-assembly that comprises a second plurality of wheels for rolling contact with a prepared or unprepared surface, and a planar second axle frame having a second steering sleeve. The second axle frame is joined to the second plurality of wheels. There is further provided a first rear stay having a first end secured to the second axle frame, with the first rear stay extending at an acute angle relative to a geometrical plane containing the second axle frame, and a second rear stay having a first end secured to the second axle frame, with the second rear stay extending at an acute angle relative to the geometrical plane containing the second axle frame. The first and second rear stays are each adapted to be fastened to a third beam of the planar rectangular chassis frame positioned across from the first beam. The first steering stay is detachably joined to the first rear stay, and the second steering stay is detachably joined to the second rear stay.

These and other aspects of the present inventions are described in the drawings annexed hereto, and in the description of the preferred embodiments and claims set forth below.

### BRIEF DESCRIPTION OF THE DRAWINGS

FIG. 1 depicts a perspective view of a transporter of the present inventions.

FIG. 2 depicts a perspective view of a chassis assembly of the present inventions.

FIG. 3A depicts a perspective view of an axle sub-assembly of the present inventions, and FIG. 3B depicts a perspective view of a steering sub-assembly of the present inventions.

FIG. 4 depicts a perspective view of a forward assembly of the present inventions.

FIG. 5 depicts a perspective view of a mounting assembly of the present inventions.

FIG. 6 depicts a perspective view of a trailing assembly of the present inventions, with the accessory shelf omitted for clarity.

FIG. 7A depicts a side view of a transporter of the present inventions, FIG. 7B is a cut-away view taken along section line A-A′ shown in FIG. 7A, and FIG. 7C is a cut-away view taken along section line B-B′ shown in FIG. 7A.

FIG. 8A depicts a front view of a transporter of the present inventions, FIG. 8B is a cut-away view taken along section line C-C′ shown in FIG. 8A, FIG. 8C is a detailed view of region X shown in FIG. 8B, and FIG. 8D is a detailed view of region Y shown in FIG. 8B.

FIG. 9A depicts a perspective view of a folded structure, FIG. 9B depicts a side view of a transporter of the present inventions with the folded structure shown in FIG. 9A loaded thereon, and FIG. 9C depicts a perspective view of the folded structure shown in FIG. 9A when fully unfolded.

FIG. 10 depicts a perspective view of the region of connection between two transporters joined in tandem in accordance with the present inventions.

FIG. 11 depicts a stacked transporter transport assembly of the present inventions.

FIG. 12 depicts a perspective view of a rolling component transport assembly of the present inventions.

FIG. 13 depicts a perspective view of a rolling component transport assembly train of the present inventions.

FIG. 14A depicts a perspective view of a stacked rolling component transport assembly train of the present inventions.

FIG. 14B depicts a perspective view of details of the stacking arrangement of the stacked rolling component transport assembly train of the present inventions shown in FIG. 14A.

### DETAILED DESCRIPTION OF THE PREFERRED EMBODIMENTS

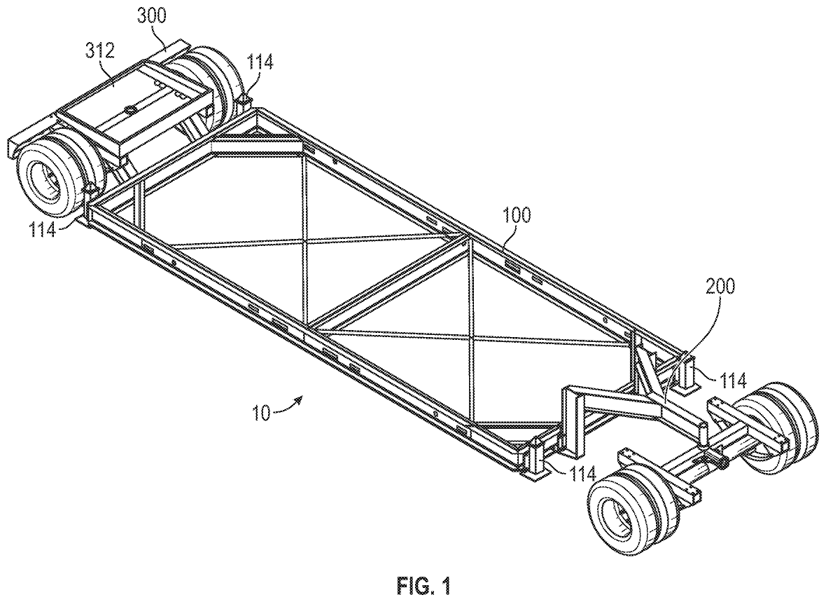

FIG. 1 shows a transporter 10, which has as its principal components a chassis assembly 100, a forward assembly 200 and a trailing assembly 300. Each of these assemblies are described below.

Chassis Assembly (100)

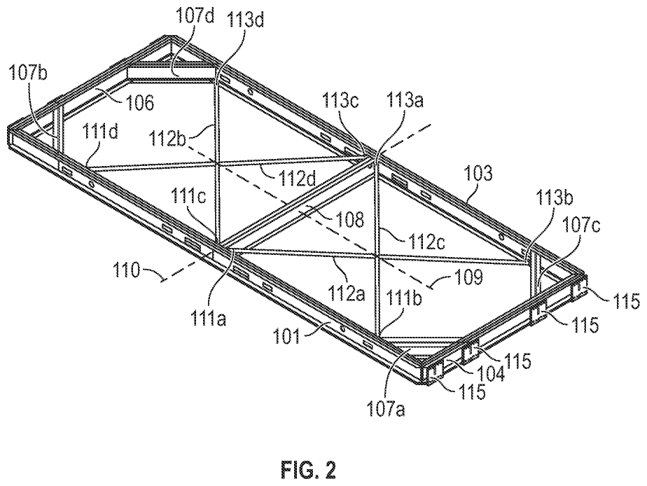

Chassis assembly 100, shown generally in FIG. 1 and more particularly in FIG. 2, has a rectangular shape defined by a linear first longitudinal I-beam 101 having a first end and an opposed second end, a linear second longitudinal I-beam 103 having a first end and an opposed second end, a linear first transverse I-beam 104 having a first end and an opposed second end and a linear second transverse linear I-beam 106 having a first end and an opposed second end. The first end of the first longitudinal I-beam 101 is joined to the first end of the first transverse I-beam 104 at a ninety degree (90°) angle, the second end of the first longitudinal I-beam 101 is joined to the first end of the second transverse I-beam 106 at a ninety degree (90°) angle, the first end of the second longitudinal I-beam 103 is joined to the second end of the first transverse I-beam 104 at a ninety degree (90°) angle, and the second end of the second longitudinal I-beam 103 is joined to the second end of the second transverse I-beam 106 at a ninety degree (90°) angle. It is preferred that I-beams 101, 103, 104 and 106 be joined by welding.

Midway between the first transverse I-beam 104 and the second transverse I-beam 106, there is provided a transverse mid-chassis I-beam 108 that divides chassis assembly 100 into first and second open frames. Mid-chassis I-beam 108 has a first end and an opposed second end, with the first end of mid-chassis I-beam 108 being joined to first longitudinal I-beam 101 at a ninety degree (90°) angle, and the second end of mid-chassis I-beam 108 being joined to second longitudinal I-beam 103 at a ninety degree (90°) angle. It is preferred that mid-chassis I-beam 108 be joined to first longitudinal I-beam 101 and second longitudinal I-beam 103 by welding.

Four inside I-beam corner gussets 107, shown in FIG. 2, are provided at the corners of chassis assembly 100 to stiffen chassis assembly 100 against parallelogram deformation. In particular, gusset 107a is joined to first longitudinal I-beam 101 and to first transverse I-beam 104, gusset 107b is joined to first longitudinal I-beam 101 and to second transverse I-beam 106, gusset 107c is joined to second longitudinal I-beam 103 and to first transverse I-beam 104, and gusset 107d is joined to second longitudinal I-beam 103 and to second transverse I-beam 106. It is preferred that these corner gussets 107 be joined to first longitudinal I-beam 101, second longitudinal I-beam 103, first transverse I-beam 104 and second transverse I-beam 106 by welding.

In addition, FIG. 2 also shows four elongate chassis tubes 112, each having a first end and an opposed second end, to stiffen chassis 100 against torsional deformation. In particular, the first end of chassis tube 112a is joined to a junction point 111a located at or near the upper portion of the junction between first longitudinal I-beam 101 and mid-chassis I-beam 108, and the second end of chassis tube 112a is joined to a junction point 113b located at or near the lower portion of the junction between second longitudinal beam 103 and gusset 107c. In addition, the first end of chassis tube 112b is joined to a junction point 111c located at or near the upper portion of the junction between first longitudinal I-beam 101 and mid-chassis I-beam 108, and the second end of chassis tube 112b is joined to a junction point 113d located at or near the lower portion of the junction between second longitudinal beam 103 and gusset 107d. Furthermore, the first end of chassis tube 112c is joined to a junction point 113a located at or near the upper portion of the junction between second longitudinal I-beam 103 and mid-chassis I-beam 108, and the second end of chassis tube 112c is joined to a junction point 111b located at or near the lower portion of the junction between first longitudinal beam 101 and gusset 107a. Correspondingly, the first end of chassis tube 112d is joined to a junction point 113c located at or near the upper portion of the junction between second longitudinal I-beam 103 and mid-chassis I-beam 108, and the second end of chassis tube 112d is joined to a junction point 111d located at or near the lower portion of the junction between first longitudinal beam 101 and gusset 107b.

It is preferred that the first and second ends of the four chassis tubes 112 be joined to their junction points by welding. The crossing point of chassis tubes 112a and 112c can either remain un-joined or be joined, as by welding, in accordance with preference, and the crossing point of chassis tubes 112b and 112b can either remain un-joined or be joined, as by welding, in accordance with preference.

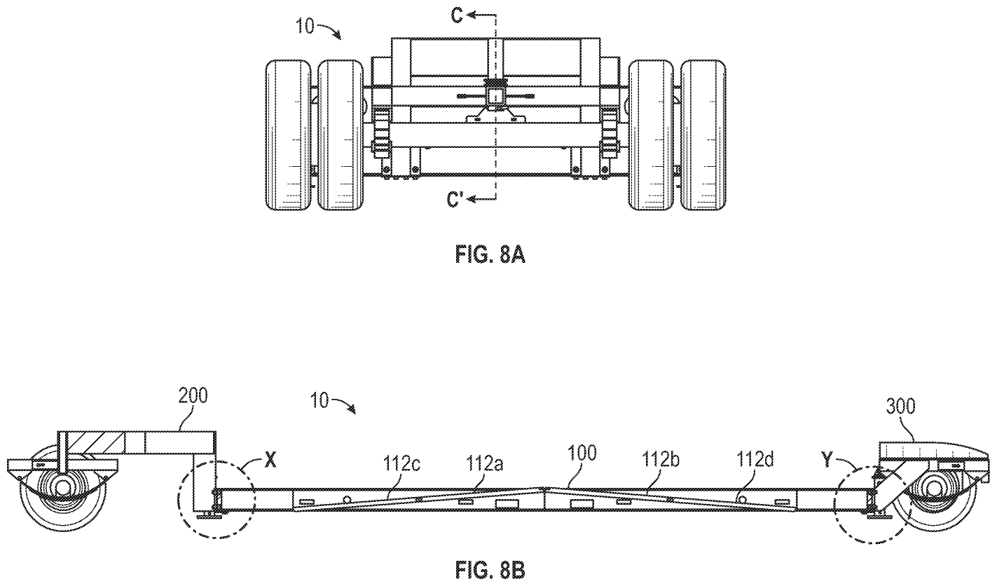

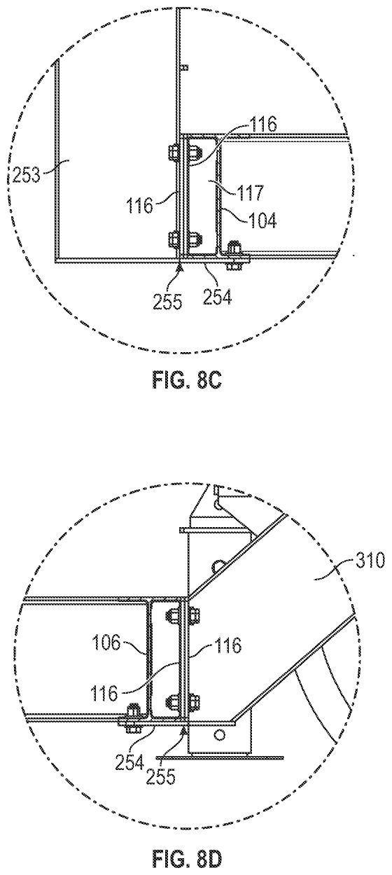

To provide mounting points on chassis assembly 100 for forward assembly 200, trailing assembly 300, as well as for jacks 114 (each described below), eight mounting assemblies 115 are secured to the exterior sides of transverse beams 104 and 106 of chassis 100; an exemplary mounting assembly 115 is shown in FIG. 5. Four of these mounting assemblies 115 are secured to first transverse I-beam 104, two to each side of longitudinal centerline 109. A first pair of mounting assemblies 115 (outboard mounting assemblies) are secured proximate the ends of first transverse I-beam 104 at equal distances from longitudinal centerline 109, and a second pair of mounting assemblies 115 (inboard mounting assemblies) are secured to first transverse I-beam 104 between the first pair at equal distances from longitudinal centerline 109. Similarly, a third pair of mounting assemblies 115 (outboard mounting assemblies) are secured proximate the ends of second transverse I-beam 106 at equal distances from longitudinal centerline 109, and a fourth pair of mounting assemblies 115 (inboard mounting assemblies) are secured to second transverse I-beam 106 between the third pair at equal distances from longitudinal centerline 109. There is provided a first set of linearly spaced-apart apertures along the inside lower flange of first transverse I-beam 104 adjacent to each of the second pair of mounting assemblies 115, and there is provided a second set of linearly spaced-apart apertures along the inside lower flange of second transverse I-beam 106 adjacent to each of the fourth pair of mounting assemblies 115. A vertically-oriented bolt can be seen in in FIG. 8C to pass through one of the first set of linearly spaced-apart apertures, and a vertically-oriented bolt can be seen in in FIG. 8D to pass through one of the second set of linearly spaced-apart apertures.

Each mounting assembly 115, shown in FIG. 5, comprises a mounting plate 116 and a mounting rib 117. Mounting plate 116 is a rectangular plate with two spaced-apart vertically aligned slots 118a formed along the vertical centerline of mounting plate 116. A number of mounting holes 119 are symmetrically positioned about the vertical centerline of mounting plate 116. Mounting rib 117 is a rectangular plate with four tabs 118b. A first pair of these tabs 118b are on one edge of mounting rib 117 and a second pair of these tabs 118b are on an opposed edge of mounting rib 117. Each pair of tabs 118b are spaced-apart a distance equal to the distance separating slots 118a. The first pair of tabs 118b are received in those slots 118a to form the T-shaped structure of mounting assembly 115 shown in FIG. 5. The second pair of tabs 118b are received in slots 118a (not visible in the figures) in the web of first or second transverse I-beam 106, 108, as the case may be. Mounting plate 116 is dimensioned so that its top and bottom edges rest against the outside top and outside bottom flanges of transverse I-beams 106, 108. The mounting assemblies 115 preferably are secured to transverse I-beams 106, 108 by welding.

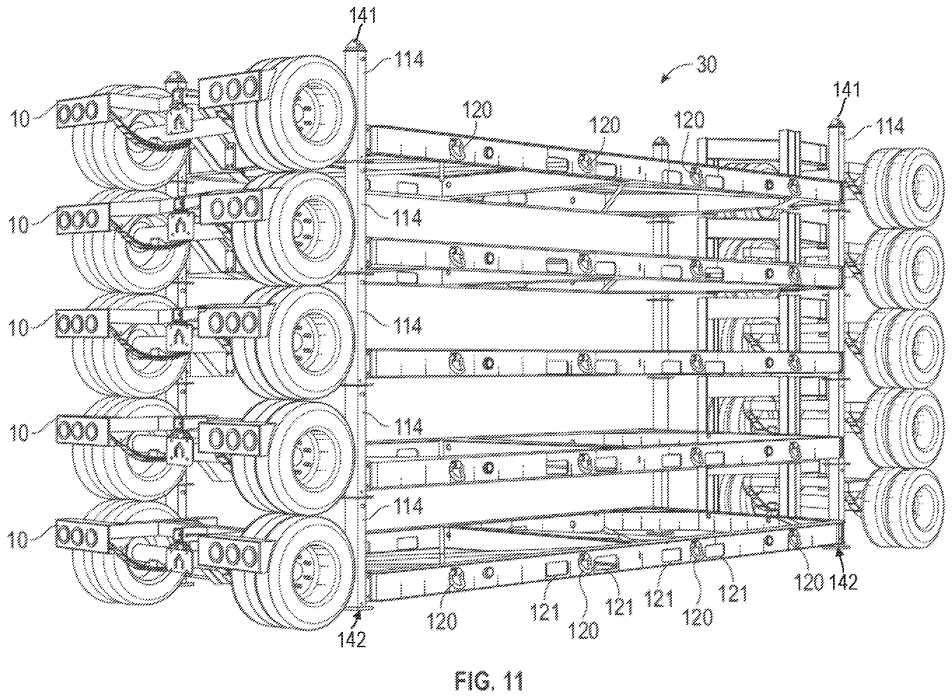

Four adjustable chassis jacks 114 are secured to chassis assembly 100, two being secured proximate each end of first transverse I-beam 104 and two being secured proximate each end of second transverse I-beam 106, as shown in FIG. 1. These adjustable chassis jacks 114 can be of various design, such as screw jacks, ratcheting jacks, pin jacks, and the like. The length of jacks 114 can be of various lengths, and also adjustability, as desired. For example, the chassis jacks 114 depicted in FIG. 11 are longer than the chassis jacks shown in FIG. 1 to facilitate stacking of multiple transporters 10, as described further below. Chassis jacks 114 are secured to the first and third (outboard) pairs of mounting assemblies 115. Each chassis jack 114 includes a mounting plate 116 with mounting holes 119 matching in number and arrangement the mounting holes 119 of the mounting assembly 115 to which chassis jack 114 is to be secured. This permit chassis jacks 114 to be secured to chassis assembly 100 by removable fasteners, such as nut and bolt fasteners. Such fasteners also permit removal of the chassis jacks 114 when desired.

Notably, chassis assembly 100 is symmetric relative to both its longitudinal centerline 109 and its transverse centerline 110. This symmetry provides certain advantages in the use of chassis assembly 100 which are described further below.

Forward Assembly (200)

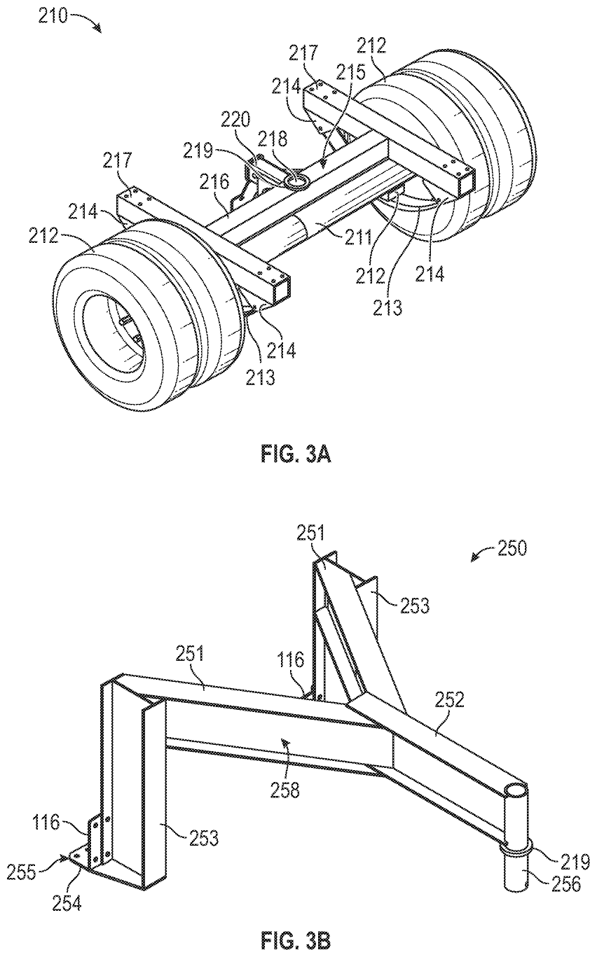

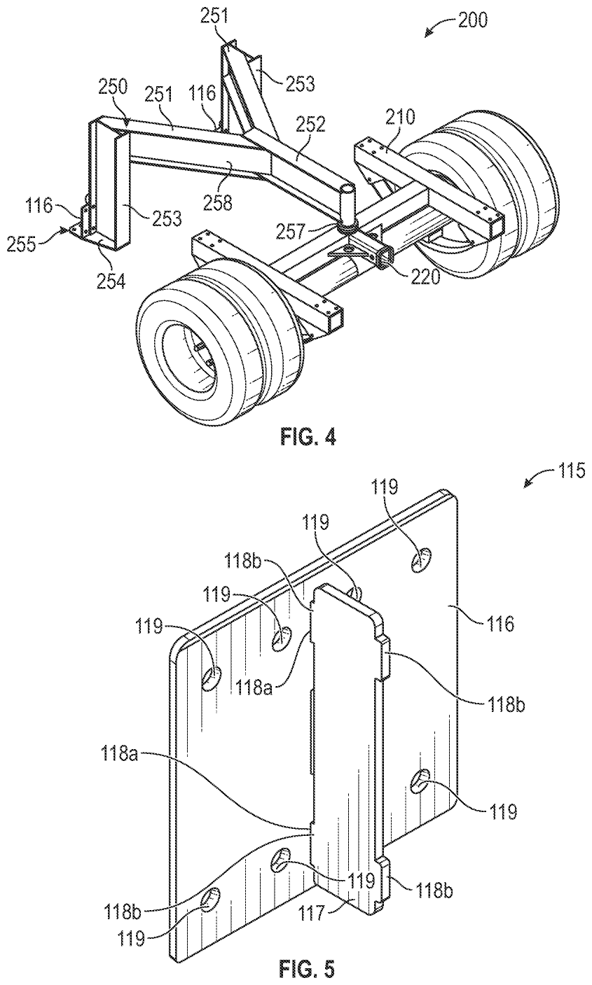

Forward assembly 200, shown in FIG. 4, comprises an axle sub-assembly 210, shown in FIG. 3A, and a steering sub-assembly 250, shown in FIG. 3B. Each is described below.

Axle Sub-Assembly (210). As shown in FIG. 3A, axle sub-assembly 210 includes an axle 211 and two wheel pairs 212 rotatably mounted on axle 211, as shown in FIG. 3, with one pair on a first end of axle 211 and a second pair on a second end of axle 211. Wheel pairs 212 are suitable for use on paved and unpaved roads and surfaces and can have a wheel diameter Wd. The axle 211 is secured to two axle carriers 212 (one of which can be seen in FIG. 3), and the axle carriers 212 are secured in turn to a pair of leaf springs 213 secured to spring hangers 214 that are mounted on H-frame 215. H-frame 215 has a planar H-shape and comprises a cross beam 216 flanked by two end beams 217. Each of beams 216, 217 in the embodiment shown in FIG. 3A has a square cross-section. The spring hangers 214 referenced above are mounted to the end beams 217, with a first pair of spring hangers 214 mounted to one of the end beams 217 and a second pair of spring hangers 214 mounted to the other of the end beams 217, as shown in FIG. 3A. A cylindrical steering sleeve 218 is inserted into an aperture located at the mid-point of cross beam 216 and secured in place, and a first steering ring bearing 219, having an annular ring shape, is positioned on cross beam 216 around the top periphery of steering sleeve 218 and secured in place. There is a hitch receiver 220 extending away from the mid-point of cross beam 216 in a geometrical plane parallel to the geometrical plane containing cross beam 216 and end beams 217. Hitch receiver 220 preferably is a class V hitch having a 2.5 inch square receiver tube and opening, which can receive a ball mount to permit transporter 10 to be towed.

Steering Sub-Assembly (250). As shown in FIG. 3B, steering sub-assembly 250 includes two steering arms 251 and a steering extender 252. Steering arms 251 are joined to steering extender 252 at an acute angle to each other so as to form a planar Y-frame 258. A first end of a first of the steering arms 251 distal from its joinder point to steering extender 252 is joined to a first steering stay 253 extending orthogonally to the geometrical plane containing Y-frame 258, and a first end of a second of the steering arms 251 distal from its joinder point to steering extender 252 is joined to a second steering stay 253 extending orthogonally to the geometrical plane containing Y-frame 258. Each of steering arms 251, steering extender 252 and steering stays 253 is an I-beam.

There is provided a steering tube 256 at the end of steering extender 252, shown in FIG. 3B, which is distal from its joinder points with steering arms 251. A second steering ring bearing 219 is fastened to steering tube 256 adjacent the lower flanges of the I-beam forming steering extender 252. Steering tube 256 is adapted to be inserted into steering sleeve 218 (shown in FIG. 3A) to provide a rotational joint between steering sub-assembly 250 and axle sub-assembly 210. The vertical loads transferred to axle sub-assembly 210 from steering extender 252 are carried on a thrust bearing 257, visible in FIG. 4, located between first steering ring bearing 219 and second steering ring bearing 219.

As generally shown in FIGS. 3B and 8C, a first chassis plate 254 is secured to the end of the first steering stay 253 distal from its joinder point to first steering arm 251, and a second chassis plate 254 is secured to the end of the second steering stay 253 distal from its joinder point to second steering arm 251. Each chassis plate 254 extends in the direction away from steering extender 252 in a geometrical plane parallel to the geometrical plane containing Y-frame 258. A first mounting plate 116 is positioned and fastened at the junction of first steering stay 253 and first chassis plate 254, and a second mounting plate 116 is positioned and fastened at the junction of second steering stay 253 and second chassis plate 254, such that two L-shaped positioning cradles 255 are formed at the lower ends of steering stays 253 distal from steering arms 251, as generally shown in FIG. 8C.

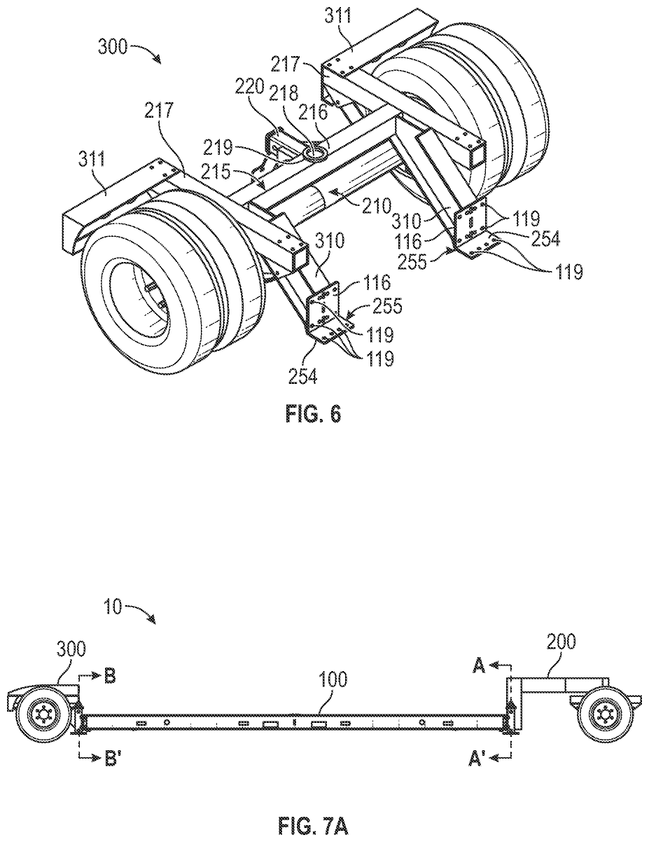

The positioning cradles 255 at the lower ends of steering stays 253 allow steering sub-assembly 250 to be detachably fastened to chassis 100. The mounting holes 119 in the mounting plates 116 affixed to steering stays 253 are intended to mate with corresponding mounting holes 119 of the mounting plates 116 of the second pair mounting assemblies 115 (inboard mounting assemblies) that are secured to first transverse I-beam 104. The flanges of the I-beams forming steering stays 253 have apertures so that the mounting plates 116 in contact with the flanges can be accessed for through-fastening, as shown in FIG. 8C. In addition, each chassis plate 254 is provided with a set of linearly spaced-apart mounting holes 119, as shown in FIG. 6, which are intended to mate with a set of linearly spaced-apart apertures along the inside lower flange of first transverse I-beam 104 adjacent to each of the second pair of mounting assemblies 115, as shown in FIG. 8C, to permit chassis plates 254 to be removably fastened to first transverse I-beam 104 using removable fasteners, such as nut and bolt fasteners.

Trailing Assembly (300)

Trailing assembly 300, shown in FIG. 6, includes an axle sub-assembly 210 which is identical in structure to the axle sub-assembly 210 included in forward assembly 200. In addition, there is a first rear stay 310, having a first end secured to H-frame 215 proximate the junction between cross beam 216 and a first of the end beams 217, and extending at an acute angle relative to the geometrical plane containing H-frame 215. There is also a second rear stay 310, having a first end secured to H-frame 215 proximate the junction between cross beam 216 and the second of the end beams 217, and extending at the acute angle relative to the geometrical plane containing H-frame 215. In a current embodiment of trailing assembly 300, the acute angle is 41.23 degrees.

An L-shaped positioning cradle 255 is fastened to the end of the first rear stay 310, and an L-shaped positioning cradle 255 is fastened to the end of the second rear stay 310. These L-shaped cradles 255 are shown in FIG. 6. The elements of L-shaped positioning cradles 255 fastened to rear stays 310 are identical in geometry to the elements of the positioning cradles 255 fastened to steering stays 253.

The positioning cradles 255 at the lower ends of rear stays 310 allow trailing assembly 300 to be detachably fastened to chassis 100. The mounting holes 119 in the mounting plates 116 affixed to rear stays 310 are intended to mate with corresponding mounting holes 119 of the mounting plates 116 of the fourth pair mounting assemblies 115 (inboard mounting assemblies) that are secured to second transverse I-beam 106. Each chassis plate 254 is provided with a set of linearly spaced-apart apertures intended to mate with the second set of linearly spaced-apart apertures along the inside lower flange of second transverse I-beam 106 adjacent to each of the fourth pair of mounting assemblies 115, as shown in FIG. 8D, to permit chassis plates 254 to be removably fastened to second transverse I-beam 106 using removable fasteners, such as nut and bolt fasteners.

As shown in FIG. 6, a first fender 311 is fastened to the end of a first of the end beams 217 at a location distal from first rear stay 310, and a second fender 311 is fastened to the end of a second of the end beams 217 at a location distal from second rear stay 310. Fenders 311 can be formed of sheet metal or plastic bent into or formed in a C-section and extend away from each other in the geometrical plane containing H-frame 215. Each fender 311 can be provided with circular apertures to receive lighting, such as brake lighting, back-up lighting, turn lighting and night lighting. An accessory shelf 312 can be secured to H-frame 215, as shown in FIG. 1, for placement of various loads, such as an electric generator, or for general storage.

To assemble transporter 10, forward assembly 200 can be positioned so that the mounting plates 116 of the L-shaped positioning cradles 255 at the lower ends of steering stays 255 are against the mounting plates 116 of the second pair (inboard) of mounting assemblies 115 on first transverse I-beam 104, and their chassis plates 254 are against the lower flanges of first transverse I-beam 104. Removable fasteners, such as nut and bolt fasteners, can then be utilized to secure forward assembly to chassis assembly 100. Similarly, trailing assembly 300 can be positioned so that the mounting plates 116 of the L-shaped positioning cradles at the lower ends of rear stays 310 are against the mounting plates 116 of the fourth pair (inboard) of mounting assemblies 115 on second transverse beam 106. Removable fasteners, such as nut and bolt fasteners, can then be utilized to secure forward assembly to chassis assembly 100. Likewise, the mounting plates 116 on jacks 114 can be positioned against the mounting plates 116 of the first and third (outboard) pairs of mounting assemblies 115 on first and second transverse beams 104, 106 and then secured with removable fasteners, such as nut and bolt fasteners. It should be noted that since chassis 100 is symmetric relative to transverse centerline 109, the identifications of first and second transverse I-beams 104, 106 are interchangeable, and thus forward assembly 200 and trailing assembly 300 each can be secured to either of those transverse I-beams.

Transporter 10 can be used to transport a wide variety of loads, such as a shipping container, a box-like structure, an elongated assembly of components or the like. In the current embodiment, the length of chassis assembly 100 (from first transverse I-beam 104 to second transverse I-beam 106) is approximately 240 inches and the width of chassis assembly 100 is approximately 94 inches. Steering stays 253 and rear stays 310 are suitably dimensioned (with rear stays 310 being angled at an acute angle of about 41.2 degrees downward from the geometrical plane containing H-frame 215) to provide a ground clearance of about 6.4 inches.

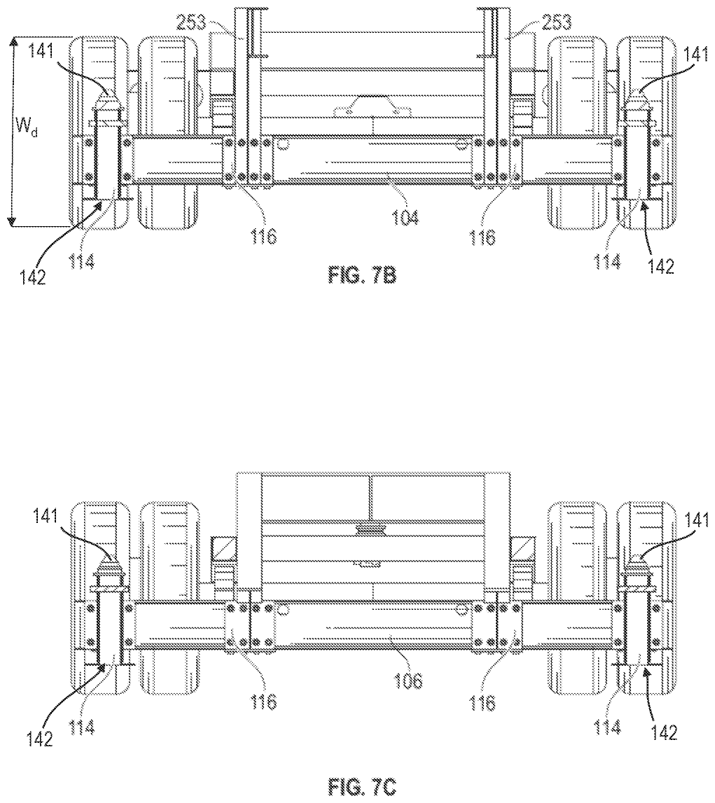

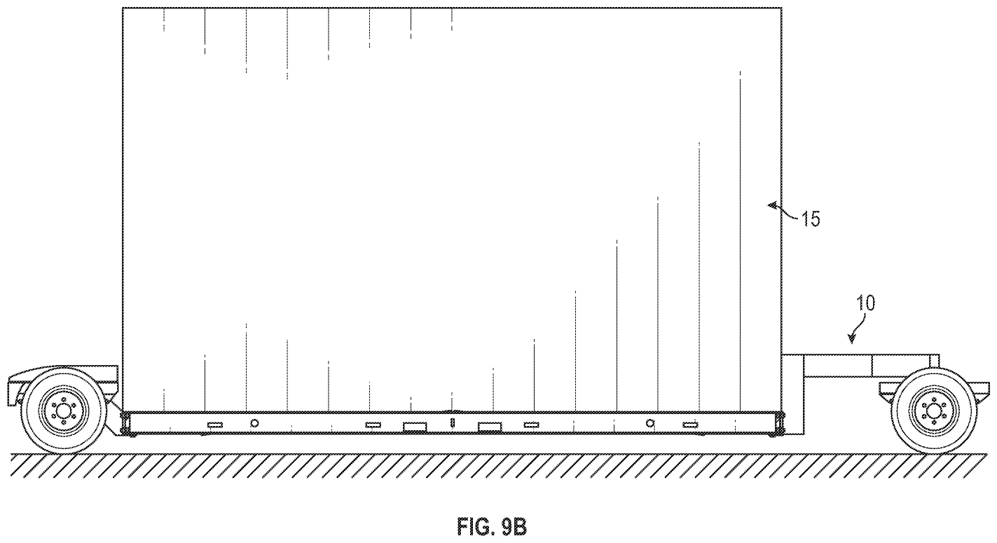

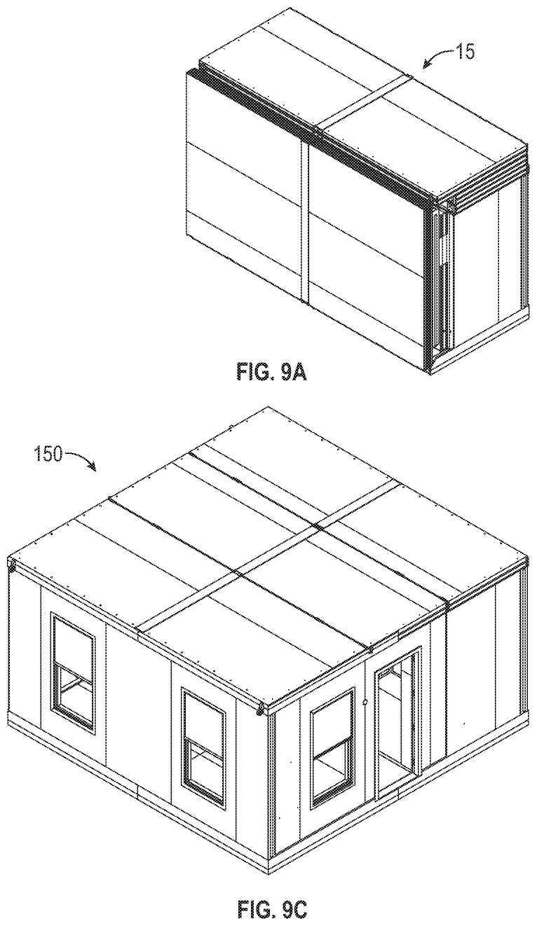

In the preferred application, the transporter 10 can be used to move a folded structure 15. An exemplary folded structure 15 of a type that can be moved with transporter 10 is shown in FIG. 9A; that folded structure is also shown in FIG. 9B when placed on a transporter 10. Folded structure 15 is of a type described for example in U.S. Nonprovisional patent application Ser. No. 17/527,520, as well as elsewhere. Folded structure 15 includes floor, wall and ceiling components having portions that are pivotally connected in a manner so that when the components are “unfolded” they form a complete structure 150, as shown in FIG. 9C. Further information about folded structure 15, including the design and structure of the components of structure 15, preferred dimensions and dimensional relationships, interior component design and other aspects relating to manufacture, assembly and deployment are disclosed for example in U.S. Nonprovisional patent application Ser. No. 17/527,520. The contents of that U.S. Nonprovisional patent application Ser. No. 17/527,520, which was filed on Nov. 16, 2021, and names as inventors Paolo Tiramani, Galiano Tiramani and Kyle Denman, are incorporated by reference as if fully set forth herein, particularly including the overview description, the description of the design and construction of the enclosure components and the floor, wall and ceiling components, the partitioning of such components, the hinge and beam assemblies used to join partitioned components, the enclosure component relationships and assembly for transport, as well as the structure deployment and finishing, which is found for example at ¶¶0038-0133, 0140-0149 and 0151-0154, and in FIGS. 1-25D and 27-28C of that U.S. Nonprovisional patent application Ser. No. 17/527,520.

Transporter 10 in the current embodiment shown in the figures and having the dimensions described above weighs approximately 3,500 lb. A current embodiment of folded structure 15 weighs approximately 13,500 lb. As a result, transporter 10 when carrying a folded structure 15 of the type described above can be towed by a pick-up truck equipped with a trailer hitch.

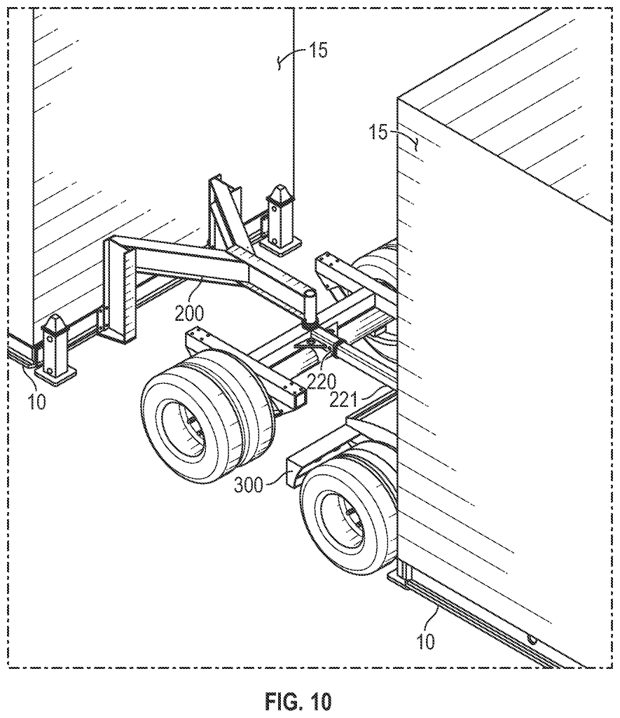

Two (or more) transporters 10 can be joined together to permit movement of multiple folded structures 15 or other such payloads at the same time. FIG. 10 depicts two transporters 10, each carrying a folded structure 15, joined in tandem. In the tandem embodiment shown, a first end of a tow bar 221 having a square section is inserted into and secured to the hitch receiver 220 of the forward assembly 200 of the aft transporter 10, and a second end of the tow bar 221 is inserted into and secured to the hitch receiver 220 (see FIG. 6; not visible in FIG. 10) of the trailing assembly 300 of the forward transport assembly 10.

The design of transporter 10 also offers a number of deployment options for a folded structure 15 of the type described above, some of which utilize the components of transporter 10 in the deployment of folded structure 15. These delivery options are described below.

Deployment Option 1: Folded Structure-Only Delivery.

With this option, a folded structure 15 is removed from transporter 10, for example using a crane or a fork lift, and placed at its final location. Transporter 10 is then towed away in unaltered form.

Deployment Option 2: Folded Structure/Transporter Delivery (Wheels on).

With this option, the folded structure 15 and the transporter 10 are both left at the final location. The chassis jacks 114 can be utilized to level the folded structure 15 if it is placed on uneven ground, to more firmly stabilize folded structure 15 than would be the case were it to remain supported only by wheel pairs 212, and to relieve wheel pairs 212 of the weight of folded structure 15 and transporter 12. Upon unfolding, the floor portion of structure 150 extending beyond chassis assembly 100 can be suitably supported as deemed appropriate.

Deployment Option 3: Folded Structure/Transporter Delivery (Wheels Off).

With this option, the folded structure 15 and chassis assembly 100 are left at the final location, while the steering assembly 250 and trailing assembly 300 may or may not be left at the final location, as the user may decide. In particular, after delivery chassis jacks 114 are first utilized to support folded structure 15 on chassis 100, following which the wheel pairs 212 are removed, but the balance of steering assembly 250 and trailing assembly 300 are left fastened to chassis assembly 100 with the folded structure 15 thereon. Alternatively, after delivery chassis jacks 114 are first utilized to support folded structure 15 on chassis 100, following which both steering assembly 250 and trailing assembly 300 can be separated and removed from chassis assembly 100 as by unbolting, leaving chassis 100 supporting folded structure 15 on chassis jacks 114. As indicated above, upon unfolding the floor portion of structure 150 extending beyond chassis assembly 100 can be suitably supported as deemed appropriate.

Deployment Option 4: Folded Structure/Chassis Delivery.

With this option, chassis 100 is placed on the ground or a suitable foundation, steering assembly 250 and trailing assembly 300 are removed (either before or after placement of chassis 100), following which any chassis jacks 114 are separated and removed from chassis assembly 100 as by unbolting, leaving chassis 100 supporting folded structure 15. Again as indicated above, upon unfolding the floor portion of structure 150 extending beyond chassis assembly 100 can be suitably supported as deemed appropriate.

The design of transporter 10 additionally offers a number of options for movement of the transporter 10 and its forward and trailing assemblies 200, 300. These options facilitate the delivery to a factory, and the return from a job site, of the transporter 10 and/or assemblies 200, 300. For illustrative purposes, the exemplary options below are directed to returns, but the concepts they describe should be understood to apply generally to the movement of the transporter 10 and assemblies 200, 300 between any two locations.

Return Option 1: Single Transporter Return.

In this return option, a single transporter 10 is towed away from the delivery site in unaltered form, such as by the truck that delivered the transporter 10 with a folded structure 15 placed thereon.

Return Option 2: Tandem Transporter Return.

In this return option, two or more transporters 10 are connected in tandem and towed away in unaltered form, in the same manner as is described above in connection with FIG. 10, using for example one of the trucks that delivered the transporters 10 with the folded structures 17 placed thereon. This liberates the other delivery truck or trucks for other uses.

Return Option 3: Stacked Transporter Return.

In this return option, two or more transporters 10 are stacked to form a stacked transporter transport assembly 30, such as that shown in FIG. 11. The stacked transporters 10 can be secured together with ratchet straps or the like. The stacked transporter transport assembly 30 can then be towed away by a truck, such as one of the trucks that delivered the transporters 10 with the folded structures 15 placed thereon. This liberates the other delivery truck or trucks for other uses.

To facilitate formation of the stacked assembly, the upper end of each jack 114 is provided with a pyramidically-shaped positioning cap 141 at its upper end and a correspondingly shaped positioning well 142 at its lower end. In stacking a second transporter 10 on a first transporter 10, each of the jacks 114 of second transporter 10 are positioned in vertical alignment with the correspondingly located jack 114 of the first transporter 10, with the positioning recesses 142 in the jacks 114 of second transporter 10 receiving and mating with the positioning caps 141 on the jacks 114 of the first transporter 10, to hold second transporter 10 in place on first transporter 10. As shown in FIG. 11, a series of folding pad eyes 120 are provided along the length of each of first and second longitudinal I-beams 101, 103 to facilitate stacking transporters 10 using a crane. Alternatively, a fork lift can be used to stack transporters 10, and for this purpose a series of apertures 121 are provided along the length of each of first and second longitudinal I-beams 101, 103 to receive the tines of a forklift. Notably, these pad eyes 120 and apertures 121 can also be employed to move to a desired location a transporter 10 with a folded structure 15 thereon, such as may be appropriate in the case of Deployment Option 4 described above.

The exemplary stacked transporter transport assembly 30 shown in FIG. 11 includes five transporters 10 in a stacked arrangement. In a currently contemplated embodiment, where each transporter 10 weighs approximately 3,500 lb., a five transporter stack would weigh approximately 17,500 lb., which is within the towing capacity of Class V trailer hitches.

Return Option 4: Multiple Steering/Trailing Assembly Return.

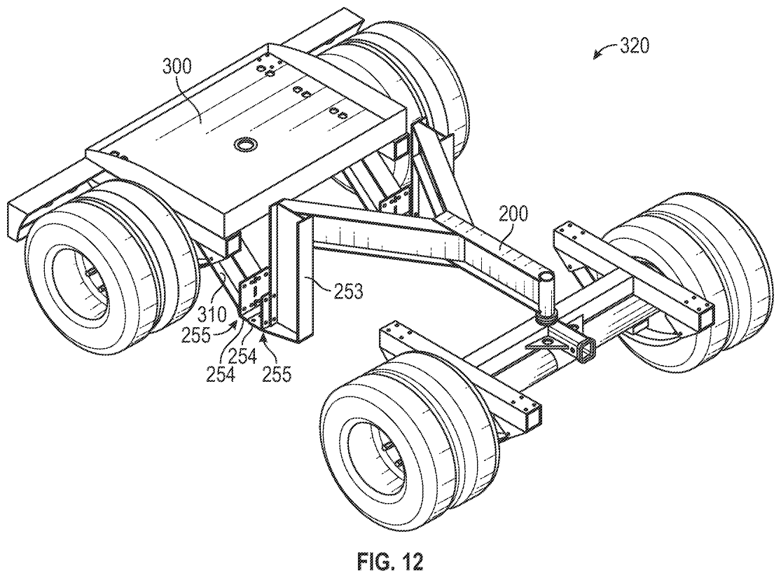

In this return option, for each transporter 10 whose chassis assembly 100 will be separated from its forward assembly 200 and trailing assembly 300, so that for example the chassis assembly 100 can remain with the structure 150 (as in Deployment Option 4, described above), the assemblies 200, 300 are first unbolted from the chassis assembly 100. After being unbolted, a forward assembly 200 and a trailing assembly 300 are positioned, as shown in FIG. 12, so that the positioning cradles 255 of steering stays 253 and rear stays 310 are in proximity, with the chassis plate 254 of the positioning cradle 255 of each steering stay 253 overlapping the chassis plate 254 of the positioning cradle 255 of the respective rear stay 310. Removable fasteners, such as nut and bolt fasteners, can then be passed through the mounting holes 119 in each of the overlapping chassis plates 254, to join together the forward assembly 200 and trailing assembly 300 and thereby create the rolling component transport assembly 320 shown in FIG. 12, which can then be towed away as a unit.

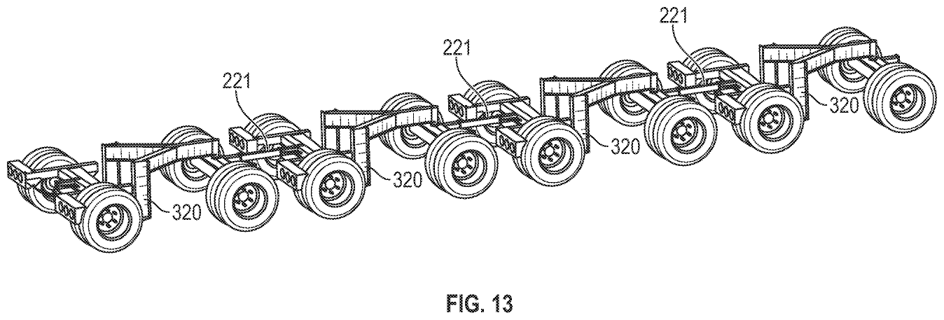

In addition, two or more rolling component assemblies 320 can be joined together to form a rolling component transport assembly train 330 made up of plural rolling component assemblies 320. In this regard, FIG. 13 depicts a rolling component assembly train 330 comprising four rolling component assemblies 320. Each of the assemblies 320 is joined to the successive and/or preceding assembly 320 using for example a tow bar 221. In particular, a first end of a tow bar 221 having a square section is inserted into and secured to the hitch receiver 220 (visible in FIG. 4) of the forward assembly 200 of an aft rolling component assembly 320, and a second end of the tow bar 221 is inserted into and secured to the hitch receiver 220 (visible in FIG. 6) of the trailing assembly 300 of the forward rolling component assembly 320. As an alternative to using tow bar 221, the two end beams 217 of the forward assembly 200 can be joined in a suitable manner directly to the corresponding two end beams 217 of the trailing assembly 300 ahead of it in succession, to form the rolling component transport assembly train 330.

Return Option 5: Stacked Multiple Steering/Trailing Assembly Return.

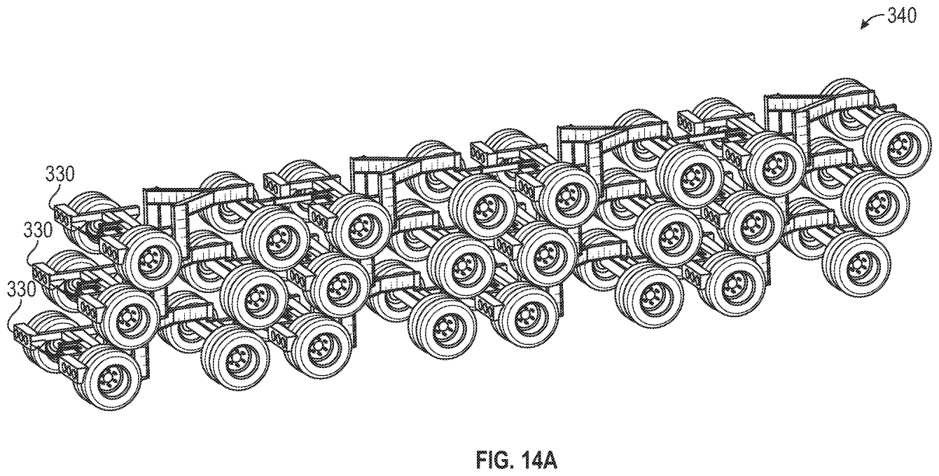

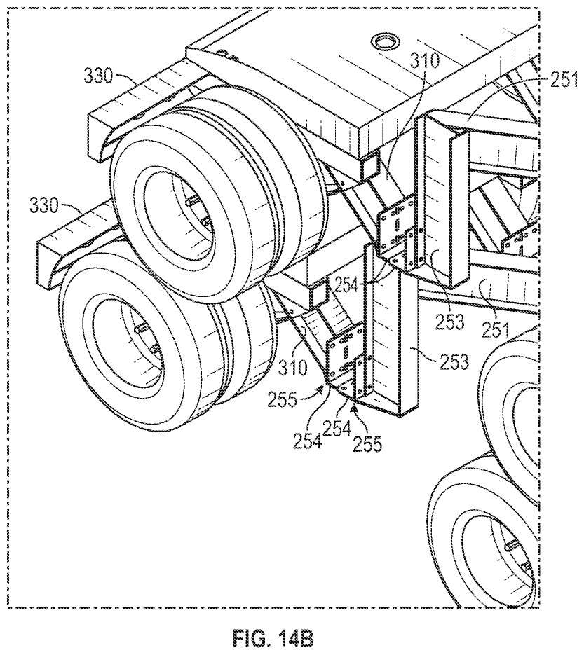

In this return option, two or more rolling component assembly trains 330 are stacked, one on top of another, to form a stacked rolling component assembly train 340. FIG. 14A depicts stacked rolling component assembly train 340 comprising three rolling component assembly trains 330, with a first train 330 rolling on the road surface, a second train 330 stacked on the first train 330, and a third train 330 stacked on the second train 330. In the embodiment depicted, the second train 330 is offset forward a distance, relative to the first train 330, so that the joined chassis plates 254 of each rolling component assembly 320 of second train 330 can rest on the upper end of a steering stay 253 and/or a steering arm 251 of the rolling component assembly 320 below it, as is shown in FIG. 14B. Alternatively where stays 253 and 310 are of suitable lengths, such an offset may not be needed and wheel pairs 212 of each of the stacked trains 330 may be vertically aligned. The stacked train 340 can be assembled piece-wise; i.e., the rolling component assemblies 320 of the second train 330 can be built up on the first train 330 assembly by assembly, with a trailing assembly 300 placed on top of the first train 330 at an appropriate position, followed by a forward assembly 200 positioned immediately forward of the trailing assembly 300, and the two assemblies 200, 300 being joined together as described above using a tow bar 221; and with these steps being repeated until the second train 330 is completed. The procedure is then repeated for the third train 330, and for any further trains 330, until the stacked rolling component assembly train 340 is completed.

This disclosure should be understood to include (as illustrative and not limiting) the subject matter set forth in the following numbered clauses:

Clause 1. A transport system, comprising:
first, second, third and fourth I-beams, joined to form a planar rectangular first chassis frame having an upper edge, a lower edge, a first corner at a junction of the first I-beam and the second I-beam, a second corner diagonally across from the first corner at a junction of the third I-beam and the fourth I-beam, a third corner at a junction of the first I-beam and the fourth I-beam and a fourth corner diagonally across from the third corner at a junction of second I-beam and the third I-beam;
a first cross-bar having a first end joined proximate to the upper edge of the first chassis frame and the first corner, and a second end joined proximate to the lower edge of the first chassis frame and the second corner; and
a second cross-bar having a first end joined proximate to the upper edge of the first chassis frame and the third corner, and a second end joined proximate to the lower edge of the first chassis frame and the fourth corner.

Clause 2. The transport system as in clause 1, further comprising fifth, sixth and seventh I-beams, the fifth I-beam joined to the second I-beam proximate to the junction of the first I-beam and the second I-beam to form a fifth corner, and the sixth I-beam joined to the fourth I-beam proximate to the junction of the first I-beam and the fourth I-beam to form a seventh corner, and the seventh I-beam joined to the sixth and fifth I-beams distal from the first I-beam to respectively form a sixth corner and an eighth corner, and to form a planar rectangular second chassis frame defined by the first, fifth, sixth and seventh I-beams and adjoining the first chassis frame, the first and second rectangular frames being coplanar, with the second chassis frame having an upper edge colinear with the upper edge of the first chassis frame and a lower edge colinear with the lower edge of the first chassis frame;
a third cross-bar having a first end joined proximate to the upper edge of the second chassis frame and the fifth corner, and a second end joined proximate to the lower edge of the second chassis frame and the sixth corner; and
a fourth cross-bar having a first end joined proximate to the upper edge of the second chassis frame and the seventh corner, and a second end joined proximate to the lower edge of the second chassis frame and the eighth corner.

Clause 3. The transport system as in clause 2, further comprising a first adjustable jack fastened to the first chassis frame proximate to the second corner, a second adjustable jack fastened to the first chassis frame proximate to the fourth corner, a third adjustable jack fastened to the second chassis frame proximate to the sixth corner, and a fourth adjustable jack fastened to the second chassis frame proximate to the eighth corner.

Clause 4. The transport chassis as in clause 3, further comprising a forward assembly having a first axle sub-assembly and a steering sub-assembly, the first axle sub-assembly having a plurality of wheels for rolling contact with a prepared or unprepared surface and connected with an articulated joint to the steering sub-assembly, the steering sub-assembly fastened to the seventh I-beam.

Clause 5. The transport system as in clause 4, wherein the first axle sub-assembly comprises:
a first axle, with a first wheel rotatably mounted on a first end of the first axle and a second wheel rotatably mounted on a second end of the first axle;
a first H-frame comprising a first cross beam having a first end joined to a first end beam and an opposed second end joined to a second end beam, the first cross beam defining an aperture mid-way between the first and second ends of the first cross-beam;
the first axle secured to the first H-frame with the first wheel flanking the first end beam and the second wheel flanking the second end beam; and wherein the articulated joint includes a first cylindrical steering sleeve inserted into the aperture defined by the first cross beam.

Clause 6. The transport system as in either of clause 4 or clause 5, wherein the steering sub-assembly comprises:
a planar Y-frame including a steering extender having a first end and a second end; a first steering arm having a first end and a second end, and a second steering arm having a first end and a second end, the first end of the first steering arm joined to the steering extender proximate to the first end thereof, the first end of the second steering arm joined to the steering extender proximate to the first end thereof, the first and second steering arms joined to the steering extender at an acute angle to each other, with the first ends of the first and second steering arms positioned proximate to each other and the second ends of the first and second steering arms positioned distal from each other;
the second end of the first steering arm joined to a first steering stay extending orthogonally to a geometrical plane containing the Y-frame, and the second end of the second steering arm joined to a second steering stay extending orthogonally to the geometrical plane containing the Y-frame, with the first and second steering stays of the steering sub-assembly fastened to the seventh I-beam; and a steering tube joined to the second end of the steering extender and inserted in the steering sleeve of the axle sub-assembly to provide the articulated joint between the axle sub-assembly and the steering sub-assembly.

Clause 7. The transport system as in any of clauses 1-6, further comprising a trailing assembly including a second axle sub-assembly having a second plurality of wheels for rolling contact with a prepared or unprepared surface, the trailing assembly fastened to the third I-beam.

Clause 8. The transport system as in clause 7, wherein the second axle sub-assembly comprises:
a second axle, with a third wheel rotatably mounted on a first end of the second axle and a fourth wheel rotatably mounted on a second end of the second axle;
a second H-frame comprising a second cross beam having a first end joined to a third end beam and an opposed second end joined to a fourth end beam, the second cross beam defining an aperture mid-way between the first and second ends of the second cross-beam;
the second axle secured to the second H-frame with the third wheel flanking the third end beam and the fourth wheel flanking the fourth end beam; and a second cylindrical steering sleeve inserted into the aperture defined by the second cross beam.

Clause 9. The transport system as in clause 8, wherein the trailing assembly further comprises:
a first rear stay having a first end secured to the second H-frame proximate to the junction between the second cross beam and the third end beam, the first rear stay extending at an acute angle relative to the geometrical plane containing the second H-frame and terminating at a second end;
a second rear stay oriented parallel to the first rear stay and having a first end secured to the second H-frame proximate to the junction between the second cross beam and the fourth end beam, the second rear stay extending at the acute angle relative to the geometrical plane containing the second H-frame and terminating at a second end; and the second end of the first rear stay fastened to the third I-beam and the second end of the second rear stay fastened to the third I-beam.

Clause 10. The transport system as in clause 9, further comprising a first fender fastened to the third end beam distal from the first rear stay and extending in the direction away from the fourth end beam, and a second fender fastened to the fourth end beam distal from the second rear stay and extending in the direction away from the third end beam.

Clause 11. The transport system as in any one of clause 8, 9 or 10, further comprising an accessory shelf secured to the second H-frame.

Clause 12. A transport system, comprising:
first, second, third and fourth I-beams, joined to form a planar rectangular first chassis frame having an upper edge and a lower edge, the first and third I-beams each joined to the second and fourth I-beams;
a first cross-bar having a first end joined proximate to the upper edge of the first chassis frame and a junction between the first and second I-beams, the first cross-bar extending diagonally away from the first and second I-beams and terminating at a second end joined to the fourth I-beam at the lower edge of the first chassis frame; and a second cross-bar having a first end joined proximate to the upper edge of the first chassis frame and a junction between the first and fourth I-beams, the second cross-bar extending diagonally away from the first and fourth I-beams and terminating at a second end joined to the second I-beam at the lower edge of the first chassis frame.

Clause 13. The transport system as in clause 12, further comprising fifth, sixth and seventh I-beams, the fifth I-beam joined to the second I-beam proximate to the junction between the first and second I-beams, the sixth I-beam joined to the fourth I-beam proximate to the junction between the first and fourth I-beams, and the seventh I-beam joined to the sixth and fifth I-beams distal from the first I-beam to form a planar rectangular second chassis frame defined by the first, fifth, sixth and seventh I-beams and adjoining the first chassis frame, the first and second rectangular frames being coplanar, with the second chassis frame having an upper edge colinear with the upper edge of the first chassis frame and a lower edge colinear with the lower edge of the first chassis frame;
a third cross-bar having a first end joined proximate to the upper edge of the second chassis frame and the junction between the first and second I-beams, the third cross-bar extending diagonally away from the first and fifth I-beams and terminating at a second end joined to the sixth I-beam proximate to the lower edge of the second chassis frame; and
a fourth cross-bar having a first end joined proximate to the upper edge of the second chassis frame and the junction between the first and fourth I-beams, the fourth cross-bar extending diagonally away from the first and sixth I-beams and terminating at a second end joined to the fifth I-beam proximate to the lower edge of the second chassis frame.

Clause 14. The transport system as in clause 13, wherein the first and second chassis frames share a longitudinal centerline parallel to the second, fourth, fifth and sixth I-beams, and there are provided first and second mounting assemblies secured to the seventh I-beam spaced from the longitudinal centerline a first equal distance, and third and fourth mounting assemblies secured to the third I-beam and spaced from the longitudinal centerline the first equal distance.

Clause 15. The transport system as in clause 14, wherein the first mounting assembly includes a first mounting plate defining an arrangement of mounting holes, the second mounting assembly includes a second mounting plate defining the arrangement of mounting holes, the third mounting assembly includes a third mounting plate defining the arrangement of mounting holes, and the fourth mounting assembly includes a fourth mounting plate defining the arrangement of mounting holes.

Clause 16. The transport chassis as in clause 15, further comprising a forward assembly having a first axle sub-assembly and a steering sub-assembly, the first axle sub-assembly having a plurality of wheels for rolling contact with a prepared or unprepared surface and connected with an articulated joint to the steering sub-assembly, the steering sub-assembly including a fifth mounting plate positioned in a mating relationship with the first mounting plate and a sixth mounting plate positioned in a mating relationship with the second mounting plate, the fifth and sixth mounting plate defining mounting holes in a matching arrangement with the respective arrangement of mounting holes of the first and second mounting plates, a removable fastener positioned in a matching pair of mounting holes of the fifth and first mounting plates, and a removable fastener positioned in a matching pair of mounting holes of the sixth and second mounting plates.

Clause 17. The transport system as in clause 16, wherein the steering sub-assembly comprises:
a planar Y-frame including a steering extender having a first end and a second end; a first steering arm having a first end and a second end, and a second steering arm having a first end and a second end, the first end of the first steering arm joined to the steering extender proximate to the first end thereof, the first end of the second steering arm joined to the steering extender proximate to the first end thereof, the first and second steering arms joined to the steering extender at an acute angle to each other, with the first ends of the first and second steering arms positioned proximate to each other and the second ends of the first and second steering arms positioned distal from each other;
the second end of the first steering arm joined to a first end of a first steering stay extending orthogonally to a geometrical plane containing the Y-frame and terminating in a second end to which is fastened a fifth mounting plate, and the second end of the second steering arm joined to a first end of a second steering stay extending orthogonally to the geometrical plane containing the Y-frame and terminating in a second end on which is fastened the sixth mounting plate.

Clause 18. The transport system as in any one of clause 15, 16 or 17, further comprising a trailing assembly including a second axle sub-assembly having a second plurality of wheels for rolling contact with a prepared or unprepared surface, the trailing assembly including a seventh mounting plate positioned in a mating relationship with the third mounting plate and an eighth mounting plate positioned in a mating relationship with the eighth mounting plate, the seventh and eighth mounting plate defining mounting holes in a matching arrangement with the respective arrangement of mounting holes of the third and fourth mounting plates, a removable fastener positioned in a matching pair of mounting holes of the seventh and third mounting plates, and a removable fastener positioned in a matching pair of mounting holes of the eighth and fourth mounting plates.

Clause 19. The transport system as in clause 18, wherein the trailing assembly further comprises:
a first rear stay extending at an acute angle relative to the geometrical plane containing the first chassis frame and terminating at a first end on which is fastened the seventh mounting plate; and
a second rear stay oriented parallel to the first rear stay and extending at the acute angle relative to the geometrical plane containing the first chassis frame and terminating at a second end on which is fastened the eighth mounting plate.

Clause 20. The transport system as in clause 19, wherein there are provided fifth and sixth mounting assemblies secured to the seventh I-beam spaced from the longitudinal centerline a second equal distance greater than the first equal distance, and seventh and eighth mounting assemblies secured to the third I-beam and spaced from the longitudinal centerline the second equal distance.

Clause 21. The transport system as in clause 20, wherein the fifth mounting assembly includes a ninth mounting plate defining the arrangement of mounting holes, the sixth mounting assembly includes a tenth mounting plate defining the arrangement of mounting holes, the seventh mounting assembly includes an eleventh mounting plate defining the arrangement of mounting holes, and the eighth mounting assembly includes a twelfth mounting plate defining the arrangement of mounting holes.

Clause 22. The transport system as in clause 21, further comprising a first adjustable jack having a thirteenth mounting plate positioned in a mating relationship with the ninth mounting plate, the thirteenth mounting plate defining mounting holes in a matching arrangement with the respective arrangement of mounting holes of the ninth mounting plate, with a removable fastener positioned in a matching pair of mounting holes of the ninth and thirteenth mounting plates; a second adjustable jack having a fourteenth mounting plate positioned in a mating relationship with the tenth mounting plate, the fourteenth mounting plate defining mounting holes in a matching arrangement with the respective arrangement of mounting holes of the tenth mounting plate, with a removable fastener positioned in a matching pair of mounting holes of the tenth and fourteenth mounting plates; a third adjustable jack having a fifteenth mounting plate positioned in a mating relationship with the eleventh mounting plate, the fifteenth mounting plate defining mounting holes in a matching arrangement with the respective arrangement of mounting holes of the eleventh mounting plate, with a removable fastener positioned in a matching pair of mounting holes of the eleventh and fifteenth mounting plates; and a fourth adjustable jack having a sixteenth mounting plate positioned in a mating relationship with the twelfth mounting plate, the sixteenth mounting plate defining mounting holes in a matching arrangement with the respective arrangement of mounting holes of the twelfth mounting plate, with a removable fastener positioned in a matching pair of mounting holes of the twelfth and sixteenth mounting plates.

Clause 23. The transport system as in any one of clauses 12-22, further comprising: a first gusset having a first end joined to the third I-beam and a second end joined to the fourth I-beam adjacent to the second end of the second cross-bar; and a second gusset having a first end joined to the third I-beam and a second end joined to the second I-beam adjacent to the second end of the first cross-bar.

Clause 24. The transport system as in any one of clauses 13-23, further comprising:
a third gusset having a first end joined to the seventh I-beam and a second end joined to the sixth I-beam adjacent to the second end of the third cross-bar; and
a fourth gusset having a first end joined to the seventh I-beam and a second end joined to the fifth I-beam adjacent to the second end of the fourth cross-bar.

Clause 25. The transport system as in clause 23, wherein the first gusset is an I-beam and the second gusset is an I-beam.

Clause 26. The transport system as in clause 24, wherein the third gusset is an I-beam and the fourth gusset is an I-beam.

Clause 27. The transport system as in any one of clauses 13-22 and 24, wherein the second and fifth I-beams are a unitary element as manufactured.

Clause 28. The transport system as in any one of clause 13-22, 24 and 27, wherein the fourth and sixth I-beams are a unitary element as manufactured.

Clause 29. A stackable transport system comprising:
first, second, third and fourth beams, joined to form a planar rectangular first chassis frame having an upper edge, a lower edge, a first corner at a junction of the first beam and the second beam, a second corner diagonally across from the first corner at a junction of the third beam and the fourth beam, a third corner at a junction of the first beam and the fourth beam and a fourth corner diagonally across from the third corner at a junction of the second beam and the third beam;
a forward assembly comprising a first axle sub-assembly and a steering sub-assembly, the first axle sub-assembly having a plurality of wheels for rolling contact with a prepared or unprepared surface and connected with an articulated joint to the steering sub-assembly, the steering sub-assembly fastened to the first beam;
a trailing assembly comprising a second axle sub-assembly having a second plurality of wheels for rolling contact with a prepared or unprepared surface, the trailing assembly fastened to the third beam;
a first extendible element fastened to the first chassis frame proximate to the first corner, a second extendible element fastened to the first chassis frame proximate to the second corner, a third extendible element fastened to the first chassis frame proximate to the third corner, and a fourth extendible element fastened to the first chassis frame proximate to the fourth corner;
each of the first, second, third and fourth extendible elements having a first end located proximate to or above the upper edge of the chassis frame and a second end located proximate to or below the lower edge of the chassis frame;
the first end of each extendible element having a first of a positioning element and a receiver element mounted thereon, and the second end of each extendible element having a second of the positioning element and the receiver element mounted thereon; and
the first of the positioning element and the receiver element of each of the first, second, third and fourth extendible elements adapted to mate with the second of the positioning element and the receiver element respectively mounted on each of a fifth, sixth, seventh and eighth extendible element fastened to a planar rectangular second chassis frame.

Clause 30. A stacked transport system transport assembly comprising:
a first transport system and a second transport system, each of the first and second transport systems comprising:
first, second, third and fourth beams, joined to form a planar rectangular first chassis frame having an upper edge, a lower edge, a first corner at a junction of the first beam and the second beam, a second corner diagonally across from the first corner at a junction of the third beam and the fourth beam, a third corner at a junction of the first beam and the fourth beam and a fourth corner diagonally across from the third corner at a junction of second beam and the third beam;
a forward assembly comprising a first axle sub-assembly and a steering sub-assembly, the first axle sub-assembly having a first plurality of wheels, each of the first plurality of wheels having a wheel diameter, the first plurality of wheels for rolling contact with a prepared or unprepared surface, the first axle sub-assembly connected with an articulated joint to the steering sub-assembly, and the steering sub-assembly fastened to the first beam;
a trailing assembly comprising a second axle sub-assembly having a second plurality of wheels, each of the second plurality of wheels having the wheel diameter, the second plurality of wheels for rolling contact with a prepared or unprepared surface, and the trailing assembly fastened to the third beam;
a first support element fastened to the first chassis frame proximate to the first corner, a second support element fastened to the first chassis frame proximate to the second corner, a third support element fastened to the first chassis frame proximate to the third corner, and a fourth support element fastened to the first chassis frame proximate to the fourth corner;
each of the first, second, third and fourth support elements having a first end located proximate to or above the upper edge of the first chassis frame and a second end located proximate to or below the lower edge of the first chassis frame;
the first end of each support element having a first of a positioning element and a receiver element mounted thereon, and the second end of each support element having a second of the positioning element and the receiver element mounted thereon; the first of the positioning element and the receiver element of each of the first, second, third and fourth support elements adapted to mate with the second of the positioning element and the receiver element mounted respectively on each of a fifth, sixth, seventh and eighth support elements fastened to a planar rectangular second chassis frame; and
wherein the second transport system is stacked on the first transport system, with the second of the positioning element and the receiver element mounted on the second end of the first support element of the second transport system in a mating relationship with the first of the positioning element and the receiver element mounted on the first end of the first support element of the first transport system.

Clause 31. The stacked transport system transport assembly of clause 30, wherein a length of each of the first, second, third and fourth support elements is equal to or greater than the wheel diameter.

Clause 32. The stacked transport system transport assembly of either of clause 30 or Clause 31, wherein each of the first, second, third and fourth support elements is an extendible support element having an unextended length and an extended length greater than the unextended length, and the extended length is equal to or greater than the wheel diameter.

Clause 33. The stacked transport system transport assembly of any one of clause 30, 31 or 32, wherein each of the first, second, third and fourth support elements is an extendible support element having an unextended length and an extended length greater than the unextended length, and the unextended length is equal to or greater than the wheel diameter.

Clause 34. The stacked transport system transport assembly of any one of clause 30, 31, 32 or 33, wherein the positioning element is a pyramidically-shaped positioning cap.

Clause 35. The stacked transport system transport assembly of any one of clauses 30-34, wherein the receiver element is a pyramidically-shaped positioning recess.

Clause 36. A rolling component transport assembly, comprising:
(a) a forward assembly having a first axle sub-assembly and a steering sub-assembly;
(b) the first axle sub-assembly comprising a first plurality of wheels for rolling contact with a prepared or unprepared surface, and a planar first axle frame having a first steering sleeve, the first axle frame joined to the first plurality of wheels;
(c) the steering sub-assembly comprising:
(i) a planar steering frame including a steering extender having a first end and a second end;
(ii) a steering tube joined to the second end of the steering extender and inserted into the first steering sleeve of the first axle sub-assembly to provide an articulated joint between the first axle sub-assembly and the steering sub-assembly;
(iii) a first steering stay joined to the steering frame and extending orthogonally to a geometrical plane containing the steering frame, and a second steering stay joined to the steering frame and extending orthogonally to the geometrical plane containing the steering frame;
(iv) the first and second steering stays each adapted to be fastened to a first beam of a planar rectangular chassis frame; and
(d) a trailing assembly comprising:
(i) a second axle sub-assembly comprising a second plurality of wheels for rolling contact with a prepared or unprepared surface, and a planar second axle frame having a second steering sleeve, the second axle frame joined to the second plurality of wheels;
(ii) a first rear stay having a first end secured to the second axle frame, the first rear stay extending at an acute angle relative to a geometrical plane containing the second axle frame;
(iii) a second rear stay having a first end secured to the second axle frame, the second rear stay extending at an acute angle relative to the geometrical plane containing the second axle frame; and
(iv) the first and second rear stays each adapted to be fastened to a third beam of the planar rectangular chassis frame positioned across from the first beam; and
(e) the first steering stay detachably joined to the first rear stay, and the second steering stay detachably joined to the second rear stay.

Clause 37. The rolling component transport assembly as in clause 36, wherein the steering frame comprises a first steering arm having a first end and a second end, and a second steering arm having a first end and a second end, the first end of the first steering arm joined to the steering extender proximate to the first end thereof, the first end of the second steering arm joined to the steering extender proximate to the first end thereof, the first and second steering arms joined to the steering extender at an acute angle to each other, with the first ends of the first and second steering arms positioned proximate to each other and the second ends of the first and second steering arms positioned distal from each other.

Clause 38. The rolling component transport assembly as in either of clause 36 or clause 37, wherein the first steering stay comprises a first steering stay plate, the second steering stay comprises a second steering stay plate, the first rear stay comprises a first rear stay plate, the second rear stay comprises a second rear stay plate, the first steering stay plate is detachably joined to the first rear stay plate, and the second steering stay plate is detachably joined to the second rear stay plate.

Clause 39. A rolling component transport assembly train, comprising:
a first rolling component transport assembly and a second rolling component transport assembly, each of the first and second rolling component transport assemblies comprising:
(a) a forward assembly having a first axle sub-assembly and a steering sub-assembly;
(b) the first axle sub-assembly comprising a first plurality of wheels for rolling contact with a prepared or unprepared surface, and a planar first axle frame having a first steering sleeve, the first axle frame joined to the first plurality of wheels;
(c) the steering sub-assembly comprising:
(i) a planar steering frame including a steering extender having a first end and a second end;
(ii) a steering tube joined to the second end of the steering extender and inserted into the first steering sleeve of the first axle sub-assembly to provide an articulated joint between the first axle sub-assembly and the steering sub-assembly;
(iii) a first steering stay joined to the steering frame and extending orthogonally to a geometrical plane containing the steering frame, and a second steering stay joined to the steering frame and extending orthogonally to the geometrical plane containing the steering frame;
(iv) the first and second steering stays each adapted to be fastened to a first beam of a planar rectangular chassis frame; and
(d) a trailing assembly comprising:
(i) a second axle sub-assembly comprising a second plurality of wheels for rolling contact with a prepared or unprepared surface, and a planar second axle frame having a second steering sleeve, the second axle frame joined to the second plurality of wheels;
(ii) a first rear stay having a first end secured to the second axle frame, the first rear stay extending at an acute angle relative to a geometrical plane containing the second axle frame;
(iii) a second rear stay having a first end secured to the second axle frame, the second rear stay extending at an acute angle relative to the geometrical plane containing the second axle frame; and
(iv) the first and second rear stays each adapted to be fastened to a third beam of the planar rectangular chassis frame positioned across from the first beam; and
(e) the first steering stay joined to the first rear stay, and the second steering stay joined to the second rear stay; and
wherein the second axle frame of the first rolling component transport assembly is joined to the first axle frame of the second rolling component transport assembly.

Clause 40. A rolling component transport assembly train as in clause 39, further comprising a rigid bar joining the second axle frame of the first rolling component transport assembly to the first axle frame of the second rolling component transport assembly.

Clause 41. A rolling component transport assembly train as in clause 39, further comprising a first hitch receiver affixed to the first axle frame of the second rolling component transport assembly and a second hitch receiver affixed to the second axle frame of the first rolling component transport assembly.

Clause 42. A rolling component transport assembly train as in clause 41, further comprising a rigid bar having a first end and a second end, the first end of the rigid bar received in and secured to the first hitch receiver, and the second end of the rigid bar received in and secured to the second hitch receiver

Clause 43. A stacked rolling component transport assembly train, comprising: a first rolling component transport assembly train and a second rolling component transport assembly train;
each of the first and second rolling component transport assembly trains comprising a first rolling component transport assembly and a second rolling component transport assembly;
each of the first and second rolling component transport assemblies comprising:
(a) a forward assembly having a first axle sub-assembly and a steering sub-assembly,
(b) the first axle sub-assembly comprising a first plurality of wheels for rolling contact with a prepared or unprepared surface, and a planar first axle frame having a first steering sleeve, the first axle frame joined to the first plurality of wheels;
(c) the steering sub-assembly comprising:
(i) a planar steering frame including a steering extender having a first end and a second end;
(ii) a steering tube joined to the second end of the steering extender and inserted into the first steering sleeve of the first axle sub-assembly to provide an articulated joint between the first axle sub-assembly and the steering sub-assembly;
(iii) a first steering stay joined to the steering frame and extending orthogonally to a geometrical plane containing the steering frame, and a second steering stay joined to the steering frame and extending orthogonally to the geometrical plane containing the steering frame;
(iv) the first and second steering stays each adapted to be fastened to a first beam of a planar rectangular chassis frame; and
(d) a trailing assembly comprising:
(i) a second axle sub-assembly comprising a second plurality of wheels for rolling contact with a prepared or unprepared surface, and a planar second axle frame having a second steering sleeve, the second axle frame joined to the second plurality of wheels;
(ii) a first rear stay having a first end secured to the second axle frame, the first rear stay extending at an acute angle relative to a geometrical plane containing the second axle frame;
(iii) a second rear stay having a first end secured to the second axle frame, the second rear stay extending at an acute angle relative to the geometrical plane containing the second axle frame; and
(iv) the first and second rear stays each adapted to be fastened to a third beam of the planar rectangular chassis frame positioned across from the first beam; and
(e) the first steering stay joined to the first rear stay, and the second steering stay joined to the second rear stay;
wherein the second axle frame of the first rolling component transport assembly of each of the first and second rolling component transport assembly trains is joined to the first axle frame of the respective second rolling component transport assembly of the first and second rolling component transport assembly trains; and wherein the second rolling component transport assembly train is stacked upon the first rolling component transport assembly train, with an upper end of the first steering stay of the first rolling component transport assembly of the first rolling component transport assembly train abutting a lower end of the first steering stay of the first rolling component transport assembly of the second rolling component transport assembly train.

The foregoing detailed description is for illustration only and is not to be deemed as limiting the inventions disclosed herein, which are defined in the appended claims.

What is claimed is:

1. A transport system, comprising:
first, second, third and fourth I-beams, joined to form a planar rectangular first chassis frame having an upper edge, a lower edge, a first corner at a junction of the first I-beam and the second I-beam, a second corner diagonally across from the first corner at a junction of the third I-beam and the fourth I-beam, a third corner at a junction of the first I-beam and the fourth I-beam and a fourth corner diagonally across from the third corner at a junction of second I-beam and the third I-beam;
a first cross-bar having a first end joined proximate to the upper edge of the first chassis frame and the first corner, and a second end joined proximate to the lower edge of the first chassis frame and the second corner; and
a second cross-bar having a first end joined proximate to the upper edge of the first chassis frame and the third corner, and a second end joined proximate to the lower edge of the first chassis frame and the fourth corner.

2. The transport system as in claim 1, further comprising fifth, sixth and seventh I-beams, the fifth I-beam joined to the second I-beam proximate to the junction of the first I-beam and the second I-beam to form a fifth corner, and the sixth I-beam joined to the fourth I-beam proximate to the junction of the first I-beam and the fourth I-beam to form a seventh corner, and the seventh I-beam joined to the sixth and fifth I-beams distal from the first I-beam to respectively form a sixth corner and an eighth corner, and to form a planar rectangular second chassis frame defined by the first, fifth, sixth and seventh I-beams and adjoining the first chassis frame, the first and second rectangular frames being coplanar, with the second chassis frame having an upper edge colinear with the upper edge of the first chassis frame and a lower edge colinear with the lower edge of the first chassis frame;
a third cross-bar having a first end joined proximate to the upper edge of the second chassis frame and the fifth corner, and a second end joined proximate to the lower edge of the second chassis frame and the sixth corner; and
a fourth cross-bar having a first end joined proximate to the upper edge of the second chassis frame and the seventh corner, and a second end joined proximate to the lower edge of the second chassis frame and the eighth corner.

3. The transport system as in claim 2, further comprising a first adjustable jack fastened to the first chassis frame proximate to the second corner, a second adjustable jack fastened to the first chassis frame proximate to the fourth corner, a third adjustable jack fastened to the second chassis frame proximate to the sixth corner, and a fourth adjustable jack fastened to the second chassis frame proximate to the eighth corner.

4. The transport chassis as in claim 3, further comprising a forward assembly having a first axle sub-assembly and a steering sub-assembly, the first axle sub-assembly having a plurality of wheels for rolling contact with a prepared or unprepared surface and connected with an articulated joint to the steering sub-assembly, the steering sub-assembly fastened to the seventh I-beam.

5. The transport system as in claim 4, wherein the first axle sub-assembly comprises:
a first axle, with a first wheel rotatably mounted on a first end of the first axle and a second wheel rotatably mounted on a second end of the first axle;
a first H-frame comprising a first cross beam having a first end joined to a first end beam and an opposed second end joined to a second end beam, the first cross beam defining an aperture mid-way between the first and second ends of the first cross-beam;
the first axle secured to the first H-frame with the first wheel flanking the first end beam and the second wheel flanking the second end beam; and
wherein the articulated joint includes a first cylindrical steering sleeve inserted into the aperture defined by the first cross beam.

6. The transport system as in claim 5, wherein the steering sub-assembly comprises:
a planar Y-frame including a steering extender having a first end and a second end; a first steering arm having a first end and a second end, and a second steering arm having a first end and a second end, the first end of the first steering arm joined to the steering extender proximate to the first end thereof, the first end of the second steering arm joined to the steering extender proximate to the first end thereof, the first and second steering arms joined to the steering extender at an acute angle to each other, with the first ends of the first and second steering arms positioned proximate to each other and the second ends of the first and second steering arms positioned distal from each other;
the second end of the first steering arm joined to a first steering stay extending orthogonally to a geometrical plane containing the Y-frame, and the second end of the second steering arm joined to a second steering stay extending orthogonally to the geometrical plane containing the Y-frame, with the first and second steering stays of the steering sub-assembly fastened to the seventh I-beam; and
a steering tube joined to the second end of the steering extender and inserted in the steering sleeve of the axle sub-assembly to provide the articulated joint between the axle sub-assembly and the steering sub-assembly.

7. The transport system as in claim 6, further comprising a trailing assembly including a second axle sub-assembly having a second plurality of wheels for rolling contact with a prepared or unprepared surface, the trailing assembly fastened to the third I-beam.

8. The transport system as in claim 7, wherein the second axle sub-assembly comprises:
a second axle, with a third wheel rotatably mounted on a first end of the second axle and a fourth wheel rotatably mounted on a second end of the second axle;
a second H-frame comprising a second cross beam having a first end joined to a third end beam and an opposed second end joined to a fourth end beam, the second cross beam defining an aperture mid-way between the first and second ends of the second cross-beam;
the second axle secured to the second H-frame with the third wheel flanking the third end beam and the fourth wheel flanking the fourth end beam; and
a second cylindrical steering sleeve inserted into the aperture defined by the second cross beam.

9. The transport system as in claim 8, wherein the trailing assembly further comprises:
a first rear stay having a first end secured to the second H-frame proximate to the junction between the second cross beam and the third end beam, the first rear stay extending at an acute angle relative to the geometrical plane containing the second H-frame and terminating at a second end;
a second rear stay having a first end secured to the second H-frame proximate to the junction between the second cross beam and the fourth end beam, the second rear stay extending at the acute angle relative to the geometrical plane containing the second H-frame and terminating at a second end; and
the second end of the first rear stay fastened to the third I-beam and the second end of the second rear stay fastened to the third I-beam.

10. The transport system as in claim 9, further comprising a first fender fastened to the third end beam distal from the first rear stay and extending in the direction away from the fourth end beam, and a second fender fastened to the fourth end beam distal from the second rear stay and extending in the direction away from the third end beam.

11. The transport system as in claim 10, further comprising an accessory shelf secured to the second H-frame.

12. A transport system, comprising:
first, second, third and fourth I-beams, joined to form a planar rectangular first chassis frame having an upper edge and a lower edge, the first and third I-beams each joined to the second and fourth I-beams;
a first cross-bar having a first end joined proximate to the upper edge of the first chassis frame and a junction between the first and second I-beams, the first cross-bar extending diagonally away from the first and second I-beams and terminating at a second end joined to the fourth I-beam at the lower edge of the first chassis frame; and
a second cross-bar having a first end joined proximate to the upper edge of the first chassis frame and a junction between the first and fourth I-beams, the second cross-bar extending diagonally away from the first and fourth I-beams and terminating at a second end joined to the second I-beam at the lower edge of the first chassis frame.

13. The transport system as in claim 12, further comprising fifth, sixth and seventh I-beams, the fifth I-beam joined to the second I-beam proximate to the junction between the first and second I-beams, the sixth I-beam joined to the fourth I-beam proximate to the junction between the first and fourth I-beams, and the seventh I-beam joined to the sixth and fifth I-beams distal from the first I-beam to form a planar rectangular second chassis frame defined by the first, fifth, sixth and seventh I-beams and adjoining the first chassis frame, the first and second rectangular frames being coplanar, with the second chassis frame having an upper edge colinear with the upper edge of the first chassis frame and a lower edge colinear with the lower edge of the first chassis frame;
a third cross-bar having a first end joined proximate to the upper edge of the second chassis frame and the junction between the first and second I-beams, the third cross-bar extending diagonally away from the first and fifth I-beams and terminating at a second end joined to the sixth I-beam proximate to the lower edge of the second chassis frame; and
a fourth cross-bar having a first end joined proximate to the upper edge of the second chassis frame and the junction between the first and fourth I-beams, the fourth cross-bar extending diagonally away from the first and sixth I-beams and terminating at a second end joined to the fifth I-beam proximate to the lower edge of the second chassis frame.

14. The transport system as in claim 13, wherein the first and second chassis frames share a longitudinal centerline parallel to the second, fourth, fifth and sixth I-beams, and there are provided first and second mounting assemblies secured to the seventh I-beam spaced from the longitudinal centerline a first equal distance, and third and fourth mounting assemblies secured to the third I-beam and spaced from the longitudinal centerline the first equal distance.

15. The transport system as in claim 14, wherein the first mounting assembly includes a first mounting plate defining an arrangement of mounting holes, the second mounting assembly includes a second mounting plate defining the arrangement of mounting holes, the third mounting assembly includes a third mounting plate defining the arrangement of mounting holes, and the fourth mounting assembly includes a fourth mounting plate defining the arrangement of mounting holes.

16. The transport chassis as in claim 15, further comprising a forward assembly having a first axle sub-assembly and a steering sub-assembly, the first axle sub-assembly having a plurality of wheels for rolling contact with a prepared or unprepared surface and connected with an articulated joint to the steering sub-assembly, the steering sub-assembly including a fifth mounting plate positioned in a mating relationship with the first mounting plate and a sixth mounting plate positioned in a mating relationship with the second mounting plate, the fifth and sixth mounting plate defining mounting holes in a matching arrangement with the respective arrangement of mounting holes of the first and second mounting plates, a removable fastener positioned in a matching pair of mounting holes of the fifth and first mounting plates, and a removable fastener positioned in a matching pair of mounting holes of the sixth and second mounting plates.

17. The transport system as in claim 16, wherein the steering sub-assembly comprises:
a planar Y-frame including a steering extender having a first end and a second end; a first steering arm having a first end and a second end, and a second steering arm having a first end and a second end, the first end of the first steering arm joined to the steering extender proximate to the first end thereof, the first end of the second steering arm joined to the steering extender proximate to the first end thereof, the first and second steering arms joined to the steering extender at an acute angle to each other, with the first ends of the first and second steering arms positioned proximate to each other and the second ends of the first and second steering arms positioned distal from each other;
the second end of the first steering arm joined to a first end of a first steering stay extending orthogonally to a geometrical plane containing the Y-frame and terminating in a second end to which is fastened a fifth mounting plate, and the second end of the second steering arm joined to a first end of a second steering stay extending orthogonally to the geometrical plane containing the Y-frame and terminating in a second end on which is fastened the sixth mounting plate.

18. The transport system as in claim 17, further comprising a trailing assembly including a second axle sub-assembly having a second plurality of wheels for rolling contact with a prepared or unprepared surface, the trailing assembly including a seventh mounting plate positioned in a mating relationship with the third mounting plate and an eighth mounting plate positioned in a mating relationship with the eighth mounting plate, the seventh and eighth mounting plate defining mounting holes in a matching arrangement with the respective arrangement of mounting holes of the third and fourth mounting plates, a removable fastener positioned in a matching pair of mounting holes of the seventh and third mounting plates, and a removable fastener positioned in a matching pair of mounting holes of the eighth and fourth mounting plates.

19. The transport system as in claim 18, wherein the trailing assembly further comprises:
a first rear stay extending at an acute angle relative to the geometrical plane containing the first chassis frame and terminating at a first end on which is fastened the seventh mounting plate; and
a second rear stay extending at the acute angle relative to the geometrical plane containing the first chassis frame and terminating at a second end on which is fastened the eighth mounting plate.

20. The transport system as in claim 19, wherein there are provided fifth and sixth mounting assemblies secured to the seventh I-beam spaced from the longitudinal centerline a second equal distance greater than the first equal distance, and seventh and eighth mounting assemblies secured to the third I-beam and spaced from the longitudinal centerline the second equal distance.

21. The transport system as in claim 20, wherein the fifth mounting assembly includes a ninth mounting plate defining the arrangement of mounting holes, the sixth mounting assembly includes a tenth mounting plate defining the arrangement of mounting holes, the seventh mounting assembly includes an eleventh mounting plate defining the arrangement of mounting holes, and the eighth mounting assembly includes a twelfth mounting plate defining the arrangement of mounting holes.

22. The transport system as in claim 21, further comprising a first adjustable jack having a thirteenth mounting plate positioned in a mating relationship with the ninth mounting plate, the thirteenth mounting plate defining mounting holes in a matching arrangement with the respective arrangement of mounting holes of the ninth mounting plate, with a removable fastener positioned in a matching pair of mounting holes of the ninth and thirteenth mounting plates; a second adjustable jack having a fourteenth mounting plate positioned in a mating relationship with the tenth mounting plate, the fourteenth mounting plate defining mounting holes in a matching arrangement with the respective arrangement of mounting holes of the tenth mounting plate, with a removable fastener positioned in a matching pair of mounting holes of the tenth and fourteenth mounting plates; a third adjustable jack having a fifteenth mounting plate positioned in a mating relationship with the eleventh mounting plate, the fifteenth mounting plate defining mounting holes in a matching arrangement with the respective arrangement of mounting holes of the eleventh mounting plate, with a removable fastener positioned in a matching pair of mounting holes of the eleventh and fifteenth mounting plates; and a fourth adjustable jack having a sixteenth mounting plate positioned in a mating relationship with the twelfth mounting plate, the sixteenth mounting plate defining mounting holes in a matching arrangement with the respective arrangement of mounting holes of the twelfth mounting plate, with a removable fastener positioned in a matching pair of mounting holes of the twelfth and sixteenth mounting plates.

23. The transport system as in claim 13, wherein the second and fifth I-beams are a unitary element as manufactured.

24. The transport system as in claim 13, wherein the fourth and sixth I-beams are a unitary element as manufactured.

25. A stacked transport system transport assembly comprising:
a first transport system and a second transport system, each of the first and second transport systems comprising:
first, second, third and fourth beams, joined to form a planar rectangular first chassis frame having an upper edge, a lower edge, a first corner at a junction of the first beam and the second beam, a second corner diagonally across from the first corner at a junction of the third beam and the fourth beam, a third corner at a junction of the first beam and the fourth beam and a fourth corner diagonally across from the third corner at a junction of second beam and the third beam;
a forward assembly comprising a first axle sub-assembly and a steering sub-assembly, the first axle sub-assembly having a first plurality of wheels, each of the first plurality of wheels having a wheel diameter, the first plurality of wheels for rolling contact with a prepared or unprepared surface, the first axle sub-assembly connected with an articulated joint to the steering sub-assembly, and the steering sub-assembly fastened to the first beam;
a trailing assembly comprising a second axle sub-assembly having a second plurality of wheels, each of the second plurality of wheels having the wheel diameter, the second plurality of wheels for rolling contact with a prepared or unprepared surface, and the trailing assembly fastened to the third beam;
a first support element fastened to the first chassis frame proximate to the first corner, a second support element fastened to the first chassis frame proximate to the second corner, a third support element fastened to the first chassis frame proximate to the third corner, and a fourth support element fastened to the first chassis frame proximate to the fourth corner;
each of the first, second, third and fourth support elements having a first end located proximate to or above the upper edge of the first chassis frame and a second end located proximate to or below the lower edge of the first chassis frame;
the first end of each support element having a first of a positioning element and a receiver element mounted thereon, and the second end of each support element having a second of the positioning element and the receiver element mounted thereon;
the first of the positioning element and the receiver element of each of the first, second, third and fourth support elements adapted to mate with the second of the positioning element and the receiver element mounted respectively on each of a fifth, sixth, seventh and eighth support elements fastened to a planar rectangular second chassis frame; and
wherein the second transport system is stacked on the first transport system, with the second of the positioning element and the receiver element mounted on the second end of the first support element of the second transport system in a mating relationship with the first of the positioning element and the receiver element mounted on the first end of the first support element of the first transport system.

26. The stacked transport system transport assembly of claim 25, wherein a length of each of the first, second, third and fourth support elements is equal to or greater than the wheel diameter.

27. The stacked transport system transport assembly as in claim 26, wherein each of the first, second, third and fourth support elements is an extendible support element having an unextended length and an extended length greater than the unextended length, and the extended length is equal to or greater than the wheel diameter.

28. The stacked transport system transport assembly as in claim 26, wherein each of the first, second, third and fourth support elements is an extendible support element having an unextended length and an extended length greater than the unextended length, and the unextended length is equal to or greater than the wheel diameter.

29. The stacked transport system transport assembly as in claim 26, wherein the positioning element is a pyramidically-shaped positioning cap.

30. The stacked transport system transport assembly as in claim 29, wherein the receiver element is a pyramidically-shaped positioning recess.

31. A rolling component transport assembly, comprising:
(a) a forward assembly having a first axle sub-assembly and a steering sub-assembly;
(b) the first axle sub-assembly comprising a first plurality of wheels for rolling contact with a prepared or unprepared surface, and a planar first axle frame having a first steering sleeve, the first axle frame joined to the first plurality of wheels;
(c) the steering sub-assembly comprising:
(i) a planar steering frame including a steering extender having a first end and a second end;
(ii) a steering tube joined to the second end of the steering extender and inserted into the first steering sleeve of the first axle sub-assembly to provide an articulated joint between the first axle sub-assembly and the steering sub-assembly;
(iii) a first steering stay joined to the steering frame and extending orthogonally to a geometrical plane containing the steering frame, and a second steering stay joined to the steering frame and extending orthogonally to the geometrical plane containing the steering frame;
(iv) the first and second steering stays each adapted to be fastened to a first beam of a planar rectangular chassis frame; and
(d) a trailing assembly comprising:
(i) a second axle sub-assembly comprising a second plurality of wheels for rolling contact with a prepared or unprepared surface, and a planar second axle frame having a second steering sleeve, the second axle frame joined to the second plurality of wheels;
(ii) a first rear stay having a first end secured to the second axle frame, the first rear stay extending at an acute angle relative to a geometrical plane containing the second axle frame;
(iii) a second rear stay having a first end secured to the second axle frame, the second rear stay extending at an acute angle relative to the geometrical plane containing the second axle frame; and
(iv) the first and second rear stays each adapted to be fastened to a third beam of the planar rectangular chassis frame positioned across from the first beam; and
(e) the first steering stay detachably joined to the first rear stay, and the second steering stay detachably joined to the second rear stay.

32. The rolling component transport assembly as in claim 31, wherein the steering frame comprises a first steering arm having a first end and a second end, and a second steering arm having a first end and a second end, the first end of the first steering arm joined to the steering extender proximate to the first end thereof, the first end of the second steering arm joined to the steering extender proximate to the first end thereof, the first and second steering arms joined to the steering extender at an acute angle to each other, with the first ends of the first and second steering arms positioned proximate to each other and the second ends of the first and second steering arms positioned distal from each other.

33. The rolling component transport assembly as in claim 31, wherein the first steering stay comprises a first steering stay plate, the second steering stay comprises a second steering stay plate, the first rear stay comprises a first rear stay plate, the second rear stay comprises a second rear stay plate, the first steering stay plate is detachably joined to the first rear stay plate, and the second steering stay plate is detachably joined to the second rear stay plate.

34. A rolling component transport assembly train, comprising:
a first rolling component transport assembly and a second rolling component transport assembly, each of the first and second rolling component transport assemblies comprising:
(a) a forward assembly having a first axle sub-assembly and a steering sub-assembly;
(b) the first axle sub-assembly comprising a first plurality of wheels for rolling contact with a prepared or unprepared surface, and a planar first axle frame having a first steering sleeve, the first axle frame joined to the first plurality of wheels;
(c) the steering sub-assembly comprising:
(i) a planar steering frame including a steering extender having a first end and a second end;
(ii) a steering tube joined to the second end of the steering extender and inserted into the first steering sleeve of the first axle sub-assembly to provide an articulated joint between the first axle sub-assembly and the steering sub-assembly;
(iii) a first steering stay joined to the steering frame and extending orthogonally to a geometrical plane containing the steering frame, and a second steering stay joined to the steering frame and extending orthogonally to the geometrical plane containing the steering frame;
(iv) the first and second steering stays each adapted to be fastened to a first beam of a planar rectangular chassis frame; and
(d) a trailing assembly comprising:
(i) a second axle sub-assembly comprising a second plurality of wheels for rolling contact with a prepared or unprepared surface, and a planar second axle frame having a second steering sleeve, the second axle frame joined to the second plurality of wheels;
(ii) a first rear stay having a first end secured to the second axle frame, the first rear stay extending at an acute angle relative to a geometrical plane containing the second axle frame;
(iii) a second rear stay having a first end secured to the second axle frame, the second rear stay extending at an acute angle relative to the geometrical plane containing the second axle frame; and
(iv) the first and second rear stays each adapted to be fastened to a third beam of the planar rectangular chassis frame positioned across from the first beam; and
(e) the first steering stay joined to the first rear stay, and the second steering stay joined to the second rear stay; and
wherein the second axle frame of the first rolling component transport assembly is joined to the first axle frame of the second rolling component transport assembly.

35. A rolling component transport assembly train as in claim 34, further comprising a rigid bar joining the second axle frame of the first rolling component transport assembly to the first axle frame of the second rolling component transport assembly.

36. A rolling component transport assembly train as in claim 34, further comprising a first hitch receiver affixed to the first axle frame of the second rolling component transport assembly and a second hitch receiver affixed to the second axle frame of the first rolling component transport assembly.

37. A rolling component transport assembly train as in claim 36, further comprising a rigid bar having a first end and a second end, the first end of the rigid bar received in and secured to the first hitch receiver, and the second end of the rigid bar received in and secured to the second hitch receiver.

38. A stacked rolling component transport assembly train, comprising:
a first rolling component transport assembly train and a second rolling component transport assembly train;
each of the first and second rolling component transport assembly trains comprising a first rolling component transport assembly and a second rolling component transport assembly;
each of the first and second rolling component transport assemblies comprising:
(a) a forward assembly having a first axle sub-assembly and a steering sub-assembly,
(b) the first axle sub-assembly comprising a first plurality of wheels for rolling contact with a prepared or unprepared surface, and a planar first axle frame having a first steering sleeve, the first axle frame joined to the first plurality of wheels;
(c) the steering sub-assembly comprising:
(i) a planar steering frame including a steering extender having a first end and a second end;
(ii) a steering tube joined to the second end of the steering extender and inserted into the first steering sleeve of the first axle sub-assembly to provide an articulated joint between the first axle sub-assembly and the steering sub-assembly;
(iii) a first steering stay joined to the steering frame and extending orthogonally to a geometrical plane containing the steering frame, and a second steering stay joined to the steering frame and extending orthogonally to the geometrical plane containing the steering frame;
(iv) the first and second steering stays each adapted to be fastened to a first beam of a planar rectangular chassis frame; and
(d) a trailing assembly comprising:
(i) a second axle sub-assembly comprising a second plurality of wheels for rolling contact with a prepared or unprepared surface, and a planar second axle frame having a second steering sleeve, the second axle frame joined to the second plurality of wheels;
(ii) a first rear stay having a first end secured to the second axle frame, the first rear stay extending at an acute angle relative to a geometrical plane containing the second axle frame;
(iii) a second rear stay having a first end secured to the second axle frame, the second rear stay extending at an acute angle relative to the geometrical plane containing the second axle frame; and
(iv) the first and second rear stays each adapted to be fastened to a third beam of the planar rectangular chassis frame positioned across from the first beam; and
(e) the first steering stay joined to the first rear stay, and the second steering stay joined to the second rear stay;
wherein the second axle frame of the first rolling component transport assembly of each of the first and second rolling component transport assembly trains is joined to the first axle frame of the respective second rolling component transport assembly of the first and second rolling component transport assembly trains; and
wherein the second rolling component transport assembly train is stacked upon the first rolling component transport assembly train, with an upper end of the first steering stay of the first rolling component transport assembly of the first rolling component transport assembly train abutting a lower end of the first steering stay of the first rolling component transport assembly of the second rolling component transport assembly train.

39. A stackable transport system comprising:
first, second, third and fourth beams, joined to form a planar rectangular first chassis frame having an upper edge, a lower edge, a first corner at a junction of the first beam and the second beam, a second corner diagonally across from the first corner at a junction of the third beam and the fourth beam, a third corner at a junction of the first beam and the fourth beam and a fourth corner diagonally across from the third corner at a junction of the second beam and the third beam;
a forward assembly comprising a first axle sub-assembly and a steering sub-assembly, the first axle sub-assembly having a plurality of wheels for rolling contact with a prepared or unprepared surface and connected with an articulated joint to the steering sub-assembly, the steering sub-assembly fastened to the first beam;
a trailing assembly comprising a second axle sub-assembly having a second plurality of wheels for rolling contact with a prepared or unprepared surface, the trailing assembly fastened to the third beam;
a first extendible element fastened to the first chassis frame proximate to the first corner, a second extendible element fastened to the first chassis frame proximate to the second corner, a third extendible element fastened to the first chassis frame proximate to the third corner, and a fourth extendible element fastened to the first chassis frame proximate to the fourth corner;
each of the first, second, third and fourth extendible elements having a first end located proximate to or above the upper edge of the first chassis frame and a second end located proximate to or below the lower edge of the first chassis frame;
the first end of each extendible element having a first of a positioning element and a receiver element mounted thereon, and the second end of each extendible element having a second of the positioning element and the receiver element mounted thereon; and
wherein the first of the positioning element and the receiver element of each of the first, second, third and fourth extendible elements is adapted to mate with the second of the positioning element and the receiver element respectively mounted on each of a fifth, sixth, seventh and eighth extendible element fastened to a planar rectangular second chassis frame.
